(19) United States
(12) Patent Application Publication
(10) Pub. No.: US 2014/0237133 A1
(43) Pub. Date: Aug. 21, 2014

(54) PAGE DOWNLOAD CONTROL METHOD, SYSTEM AND PROGRAM FOR IE CORE BROWSER

(71) Applicant: BEIJING QIHOO TECHNOLOGY COMPANY LIMITED, Beijing (CN)

(72) Inventors: Hongwei Liu, Beijing (CN); Xi Tang, Beijing (CN)

(21) Appl. No.: 14/347,630

(22) PCT Filed: Sep. 24, 2012
(86) PCT No.: PCT/CN2012/081855

§ 371 Date: Mar. 26, 2014

(30) Foreign Application Priority Data
Sep. 26, 2011 (CN) 201110289062.5
Sep. 26, 2011 (CN) 201110289107.9
Sep. 26, 2011 (CN) 201110289108.3
Sep. 26, 2011 (CN) 201110289109.8

(51) Int. Cl. H04L 29/06

(52) U.S. Cl. CPC H04L 69/24
USPC 709/230

(57) ABSTRACT

The present invention discloses a method, a system and a program of page download control for an IE kernel browser, including: starting an IE kernel browser process and starting a preset download process; registering a communication protocol in the IE kernel browser process and waiting for a page download request based on a corresponding communication protocol; when the IE kernel browser process receives the page download request, triggering the download process to control page download according to a preset download rule; and return download status information to the IE kernel browser process during the page download procedure. The present invention is able to effectively control the page download process of the IE kernel browser and improve the efficiency and stability of the page download.

### TECHNICAL FIELD

The present invention relates to a technical field of a browser, and especially to a method of webpage download control for an IE kernel browser and a system and a program of webpage download control for an IE kernel browser.

### BACKGROUND ART

The most important part of a browser is a “Rendering Engine” which might mean “interpreting engine” and which is generally referred to as “browser kernel”. The browser kernel is responsible for interpreting the syntax of the webpage (such as HTML and JavaScript) and rendering (displaying) a webpage. Therefore, the so called browser kernel usually is an engine which performs downloading, parsing, executing and rendering on the webpage. The engine determines that how the browser display the content of the webpage and the format information of a page.

Currently, browsers popular on the market can be roughly divided into two types according to the manners of implementation:

In the first type, the developer of the browser develops not only the development of the browser kernel but also the development of a product. Examples of this type of browser are as follows: the Chrome browser, the Firefox browser, the Safari browser, the Internet Explore browser, and so on.

In the second type, the developer of the browser only develops the product, using the kernel completed by other browser producer and embedding it into its own browser. Examples of this type of browser are as follows: the 360 security browser, the Maxthon browser, TheWorld Browser, the Sogou browser and so on. These browsers often employ the kernel of the Internet Explorer browser and may be commonly referred to as “a browser using an IE kernel”.

Currently, all the IE kernel browsers available on the market were implemented directly by using a WebBrowser module provided by a system. A particular method is: creating the WebBrowser module first by an OleCreate API (Application Programming Interface), acquiring a window created by the module, embedding it into a browser window, then, calling an interface provided by the WebBrowser module to access to a Website. Throughout the process of the access, downloading, parsing, executing and rendering the webpage are performed by a code of the WebBrowser module itself. Shell program is only required to receive a notice returned from the module and accordingly change the content of the page.

For the purpose of facilitating a developers' use, interfaces provided by IE kernel are very limited. Generally, only basic interfaces such as access to webpage, stop, refresh, back and the like are available. Therefore only simple controls on the page, such as access to URL, refresh, stop, back and the like, can be achieved. For many internal situations, browser developers have no information and are unable to control. Especially, page download process can not be controlled, thus affecting the efficiency and stability of the page download.

To sum up, a technical problem needed to be addressed eagerly by the skilled in the art is how to effectively control the page download process of the IE kernel browser, in order to improve the efficiency and stability of the page download.

### SUMMARY OF THE INVENTION

In view of the above problems, the present invention is proposed to provide a method of webpage download control for an IE kernel browser as well as a corresponding system and program of webpage download control for an IE kernel browser, which may be able to overcome or at least partially relieve the problems.

According to an aspect of the present invention, there is provided a method of webpage download control for an IE kernel browser, comprising:

starting an IE kernel browser process and starting a preset download process; registering a communication protocol in the IE kernel browser process, and

waiting for a page download request based on a corresponding communication protocol;

when the IE kernel browser process receives the page download request, triggering the download process to control a page download according to a preset download rule; and

returning download status information to the IE kernel browser process during the page download procedure.

According to another aspect of the present invention, there is provided a system of webpage download control for an IE kernel browser, comprising:

a start module, configured to start an IE kernel browser process and start a preset download process;

a protocol registration module, configured to register a communication protocol in the IE kernel browser process, and wait for a page download request based on a corresponding communication protocol;

a download control module, configured to trigger the download process to control a page download according to a preset download rule, when the IE kernel browser process receives a page download request; and

a status reporting module, configured to return download status information to the IE kernel browser process during the page download procedure.

According to another aspect of the present invention, there is provided a method of webpage download control for an IE kernel browser, comprising:

starting an IE kernel browser process and starting a preset download process; registering a communication protocol in the IE kernel browser process, and

waiting for a page download request based on a corresponding communication protocol;

when the IE kernel browser process receives the page download request, sending the page download request to the download process;

adding, by the download process, the page download request to a pre-generated download task list;

acquiring a page resource type corresponding to the page download request, and in the download task list, ordering the page download request according to the page resource type;

sequentially processing the page download request in the download task list to perform a corresponding page download operation; and

returning download status information to the IE kernel browser process during the page download procedure.

According to another aspect of the present invention, there is provided a system of webpage download control for an IE kernel browser, comprising:

a start module, configured to start an IE kernel browser process and start a preset download process;

a protocol registration module, configured to register a communication protocol in the IE kernel browser process, and wait for a page download request based on a corresponding communication protocol;

a request transmission module, configured to send the page download request to the download process when the IE kernel browser process receives the page download request;

a task adding module, configured to add the page download request to a pre-generated download task list by the download process;

an ordering module, configured to acquire a page resource type corresponding to the page download request, and in the download task list, order the page download request according to the page resource type;

a download execution module, configured to sequentially process the page download request in the download task list to execute a corresponding page download operation; and

a status reporting module, configured to return download status information to the IE kernel browser process during the page download procedure.

According to another aspect of the present invention, there is provided a method of webpage download control for an IE kernel browser, comprising:

starting an IE kernel browser process and starting a preset download process; registering a communication protocol in the IE kernel browser process, and waiting for a page download request based on a corresponding communication protocol;

when the IE kernel browser process receives the page download request, sending the page download request to the download process;

acquiring, by the download process, file size information corresponding to the page download request;

when the file size information exceeds a preset threshold value of file size, employ a multi-threaded download to perform a download operation of a corresponding page; and

returning, by the download process, download status information to the IE kernel browser process during the page download procedure.

According to another aspect of the present invention, there is provided a system of webpage download control for an IE kernel browser, comprising:

a start module, configured to start an IE kernel browser process and start a preset download process;

a protocol registration module, configured to register a communication protocol in the IE kernel browser process, and wait for a page download request based on a corresponding communication protocol;

a request transmission module, configured to send the page download request to the download process when the IE kernel browser process receives the page download request;

a file size acquisition module, configured to acquire file size information corresponding to a page download request by the download process;

a multi-threaded download module, configured to, when the file size information exceeds a preset threshold value of file size, employ a multi-threaded download to perform a download operation of a corresponding page; and

a status reporting module, configured to return download status information to the IE kernel browser process during the page download procedure.

According to another aspect of the present invention, there is provided a method of webpage download control for an IE kernel browser, comprising:

step S1: starting an IE kernel browser process and starting a preset download process;

step S2: registering a communication protocol in the IE kernel browser process, and waiting for a page download request based on a corresponding communication protocol;

step S3: when the IE kernel browser process receives the page download request, sending the page download request to the download process;

step S4: determines, by the download process, whether the requested file has been pre-written into a cache according to the page download request; wherein if yes, execute step S5; otherwise, execute steps S6, S7, and S8;

step S5: extracting the file from the cache;

step S6: downloading a corresponding file from a server according to the page download request;

step S7: returning the download status information to the IE kernel browser process in the download procedure; and

step S8: writing the downloaded file into the cache.

According to another aspect of the present invention, there is provided a system of webpage download control for an IE kernel browser, comprising:

a start module, configured to start an IE kernel browser process and start a preset download process;

a protocol registration module, configured to register a communication protocol in the IE kernel browser process, and wait for a page download request based on a corresponding communication protocol;

a request transmission module, configured to send the page download request to the download process when the IE kernel browser process receives the page download request;

a cache determination module, configured to determine whether the requested file has been pre-written into a cache by the download process according to the page download request, and if so, trigger a cache extraction module; if not, trigger a server download module, a status reporting module and a cache write-in module;

the cache extraction module, configured to extract the file from the cache;

the server download module, configured to download a corresponding file from the server according to the page download request;

the status reporting module, configured to return download status information to the IE kernel browser process during the page download procedure; and

the cache write-in module, configured to write the downloaded file into the cache.

According to still another aspect of the present invention, there is provided a computer program comprising a computer readable code, wherein when the computer readable code is operated on a client, the client may execute any one of the methods of webpage download control for an IE kernel browser as described above.

According to still another aspect of the present invention, there is provided a computer readable medium, in which the computer program is stored.

The beneficial effects of the present invention:

The present invention uses the protocol management expansion interface of the IE to take over all the download tasks of the IE kernel browser by itself, so as to allow the shell embedded in the IE kernel browser to be able to control the download of a browser kernel on its own initiative and return the download data to an IE kernel, in such a manner the IE kernel may continue to the resolution, execution and rendering operations. Since the download action does not occur in the browser process, when the download crashes due to problematic program, the browser process will not collapse. Another download process can be restarted to continue to download. Thus, the present invention can effectively control the page download process of the IE kernel browser, so as to improve the efficiency and stability of the page download.

Furthermore, the present invention may employ schemes for optimizing the download by resource ordering, multi-threaded download and cache read-write, thereby increasing the speeds of download and pages exhibition, making full use of the user's bandwidth and improving resource utilization.

The above description is merely an overview of the technical solution of the present invention. In order to understand the technical means of the present invention more clearly, implement in accordance with the content of the specification and make above and other objects, features and advantages of the present invention more apparent, there are provided detailed embodiments of the present invention hereafter.

### BRIEF DESCRIPTION OF THE DRAWINGS

Other advantages and benefits will become clear to the skilled in the art by reading the following detailed description of the preferred embodiment. The accompanying drawings are only for the purpose of illustrating the preferred embodiment, should not be constructed as limiting the present invention.

Moreover, the same components will indicated by be the same references the throughout the drawings, in which:

FIG. 1 is a flowchart schematically illustrating a method of webpage download control for an IE kernel browser according to a first method embodiment of the present invention;

FIG. 2 is a flowchart schematically illustrating a method of webpage download control for an IE kernel browser according to a second method embodiment of the present invention;

FIG. 3 is a flowchart schematically illustrating a method of webpage download control for an IE kernel browser according to a third method embodiment of the present invention;

FIG. 4 is a flowchart schematically illustrating a method of webpage download control for an IE kernel browser according to a fourth method embodiment of the present invention;

FIG. 5 is a flowchart schematically illustrating a method of webpage download control for an IE kernel browser according to a fifth method embodiment of the present invention;

FIG. 6 is a flowchart schematically illustrating a method of webpage download control for an IE kernel browser according to a sixth method embodiment of the present invention;

FIG. 7 is a flowchart schematically illustrating a method of webpage download control for an IE kernel browser according to a seventh method embodiment of the present invention;

FIG. 8 is a block diagram schematically illustrating a system of webpage download control for an IE kernel browser according to a first system embodiment of the present invention;

FIG. 9 is a block diagram schematically illustrating a system of webpage download control for an IE kernel browser according to a second system embodiment of the present invention;

FIG. 10 is a block diagram schematically illustrating a system of webpage download control for an IE kernel browser according to a third system embodiment of the present invention;

FIG. 11 is a block diagram schematically illustrating a system of webpage download control for an IE kernel browser according to a fourth system embodiment of the present invention;

FIG. 12 is a block diagram schematically illustrating a client for performing the method according to the present invention; and

FIG. 13 schematically illustrates a memory unit for keeping or carrying a program code to implement the method according to the present invention.

### DETAILED DESCRIPTION OF THE EMBODIMENTS

The present invention will be further described below in conjunction with the accompanying drawings and specific embodiments.

In the embodiment of the present invention, a shell program embedded into IE browser kernel may be allowed to a control download of a browser kernel by itself and transmit downloaded data to an IE kernel to continue the operations of parsing, executing and rendering.

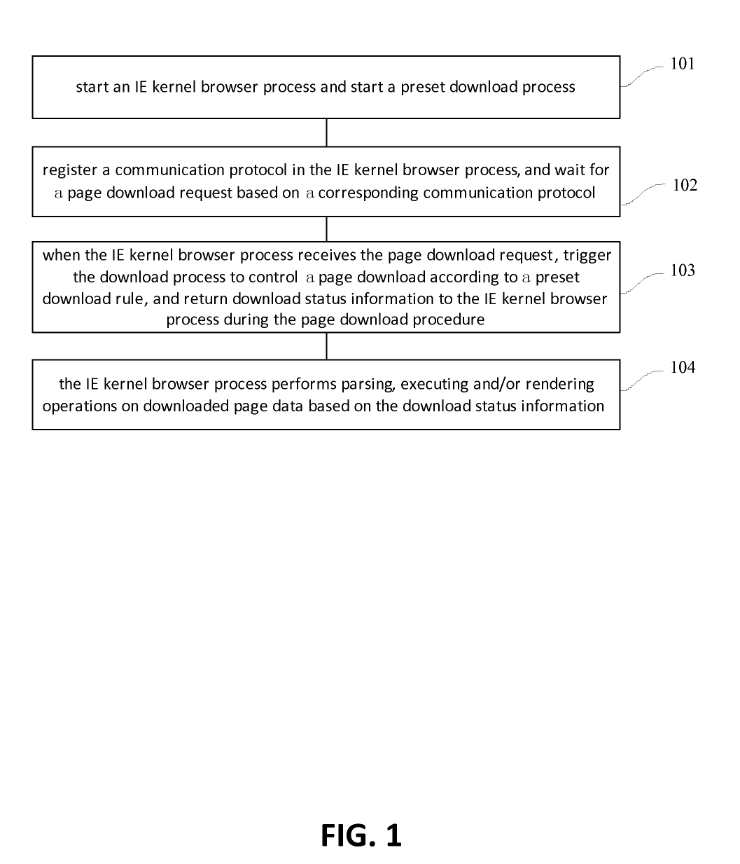

FIG. 1 is a flowchart schematically illustrating a method of webpage download control for an IE kernel browser according to a first method embodiment of the present invention. Referring to FIG. 1, the method may specifically include the following steps:

At step 101, start an IE kernel browser process and start a preset download process;

In the embodiment of the present invention, the IE kernel browser process refers to a browser process employing the kernel of an IE (Internet Explorer) browser. In the prior art, the browser kernel is responsible for downloading, parsing, executing and rendering a webpage; while in this embodiment, the kernel of the IE browser is arranged to complete the operations of parsing, executing and rendering only, and the download operation may be implemented by the preset download process.

As it is well known, a process is a program being executed, which is a routine operating in a computer; the process may be assigned to a processor executed by it as a single entity. From the angle of a user, the browser process can be understood as a process on behalf of the browser being operated in a task manager.

The download process can be understood as an additional process of the IE kernel browser, which is a process specially set for the download operation. That is, the download process is specially set for download, rather than do other operations. As a specific example implemented by the embodiment of the present invention, the interior of the download process may use WinHTTP (Microsoft Windows HTTP Services, which provide a developer with an HTTP client application programming interface (API), through which a request may be sent to other HTTP server by an HTTP protocol) to implement a downloader and a download manager. It means that the download process may include a download manager and downloaders, wherein the download manager can be set to control the page download according to a preset download rule (for example, to order and optimize a request for download a resource); the downloader can be set to implement the specific download operation and report a download state (i.e., download status information) to the IE kernel browser process through the download manager. In practice, the download process, like a service, is waiting to be called at any time after starting.

In the embodiments of the invention, the download process may be started when the IE kernel browser process is started, or in other words, the activation of the IE kernel browser process may trigger the download process to ensure the normal exhibition of a page in the browser.

At step 102, register a communication protocol in the IE kernel browser process, and wait for a page download request based on a corresponding communication protocol;

In the specific implementation, the step of registering a communication protocol in the IE kernel browser process may be: registering the communication protocol in the IE kernel browser process by using the RegisterNameSpace method of an IInternetSession interface. The communication protocol may include a http protocol (HyperText Transmission Protocol), a https protocol (SecureHypertextTransferProtocol), a mailto protocol (e-mail protocol), an FTP protocol (FileTransferProtocol) and so on.

Specifically, the RegisterNameSpace method of the IInternetSession interface requests a fixed format interface, and after registering the communication protocol in the IE kernel browser process by using this method, all the page download request employing the corresponding communication protocol may be sent to a pre-set shell interface. That is, when there is any page download request employing the corresponding communication protocol (such as the http protocol, the https protocol, the mailto protocol and the FTP protocol), the IE kernel may inform or call the preset shell interface.

At step 103, when the IE kernel browser process receives the page download request, trigger the download process to control a page download according to a preset download rule, and return download status information to the IE kernel browser process during the page download procedure.

In the specific implementation, when the IE kernel calls a Start method of the IInternetProtocol interface provided in the procedure of registering the communication protocol, the page download request may be sent to the download process through cross-process communication and an operator E_PENDING is returned to inform the IE kernel of the operation being executed. After data is downloaded, the download process may inform the IE kernel browser process which initiates the download, and then the IE kernel browser process may call a corresponding method of the IInternetProtocolSink interface provided by the IE kernel to inform the IE kernel of the download status information such as download progress and downloaded data.

More specifically, the cross-process communication means transmitting a request of a process to another process. In the present embodiment, it means transmitting the page download request of the IE kernel browser process to the download process, and during the download procedure, the download status information such as download progress and downloaded data is real-time reported to the IE kernel. The cross-process communication can use a Windows message mechanism and perform data transmission with the kernel object cooperated. For example, after the http protocol is registered in the IE browser process, once a page download request based on the http protocol is presented, it will be sent to a preset browser shell. When the IE kernel calls the shell, it may transmit the corresponding information of the page download request thereto, and the shell may pack the information (store it into a data block that mainly includes url, refresh, cookie, etc.) and send this data block to the download process via a standard channel communication provided by a Windows system. A Windows message sent to the browser process during the download procedure mainly informs the browser of the current download progress.

In short, the cross-process communication refers to two sides. Firstly, when the IE kernel browser process receives a page download request, it may inform the download process of a file to be downloaded through the cross-process communication. On the other hand, when the download request is being executed, the download process may send a message to the IE kernel browser process to inform it of the download status information such as the download progress and the downloaded data.

In a preferred embodiment of the present invention, at step 103, the step of, when the IE kernel browser process receives the page download request, triggering the download process to control a page download according to a preset download rule may specifically include the following sub-steps:

At sub-step S11, when the IE kernel browser process receives the page download request, send the page download request to the download process;

At sub-step S12, add, by the download process, the page download request to a pre-generated download task list;

At sub-step S13, acquire a page resource type corresponding to the page download request, and in the download task list, order the page download request according to the page resource type; and

At sub-step S14, sequentially process the page download request in the download task list to execute a corresponding page download operation.

In practice, the page download request may include URL information and the URL information may include extension name information. In this case, the page resource type corresponding to the page download request can be acquired by reading the extension name information.

This embodiment mainly refers to a scheme for optimizing the download by ordering the resource, which is implemented during the control of download by the download process. That is, when the browser process receives the IE download request, the download process is triggered to perform the download, and before starting the download by the downloader, the download manager may order the resource corresponding to the download request.

In a practical application, the type of a text file (such as html, css, js and the like) may be downloaded preferentially, and the type of a multimedia file (such as image, flash and other large-sized files) may be downloaded later because the exhibition of a webpage is not dependent on them. A download task list may be included in the download manager of the download process. The location where a new added download task is to be positioned in the list may be determined according to a priority. For example, since the type of the text file such as html, css and js is necessary when opening a webpage, they are positioned to the top of the list, while other multimedia type of the file such as an image and a flash is located to the end of the list. The downloader may continuously acquire tasks from the head of list to start the download. This may realize the ordering of the resource.

In practice, each of page download requests corresponds to a download task, and each of download tasks corresponds to a page resource type.

For example, assuming that the browser is visiting http://www.360.cn/, the IE kernel will generate 5 download requests, content/type/sequence of which are as follows:

http://www.360.cn/index.htm;
http://www.360.cn/360safe.css;
http://www.360.cn/product.swf;
http://www.360.cn/360safe.png;
http://www.360.cn/frame.htm.

According to a sequence consistent with the IE download request, the page download request may be sent to the download process from the IE kernel browser process.

It is assumed that the download task list in the download process is null now. When the page download request from http://www.360.cn/index.htm is received, since the list is null, it will be directly listed into a queue. As shown in Table 1, only one request is presented in the download task list.

TABLE 1

index.htm

It is known that the following page download request received from http://www.360.cn/360safe.css is a text file through its extension name, which has the same level as htm, and thus it may be positioned directly behind the first item in the download task list. As shown in Table 2, the current status of a request sequence in the download task list is as follows:

TABLE 2

index.htm
360safe.css

It is known that the following page download request received from http://www.360.cn/Product SWF is a flash file through its extension name. Since the size of this type of file is largest, it will be positioned to the bottom of the list.

As shown in Table 3, the current status of the request sequence in the download task list is as follows:

TABLE 3

index.htm
360safe.css
product.swf

It is known that the following page download request received from http://www.360.cn/360safe.png is an image file through its extension name. Since the size of this type of file is larger than the text file but less than the flash file, it may be interposed between the text type and the flash type.

As shown in Table 4, the current status of the request sequence in the download task list is as follows:

TABLE 4

index.htm
360safe.css
360safe.png
product.swf

It is known that the following page download request received from http://www.360.cn/frame.htm is an htm file through its extension name, and then it may be inserted behind all the text files.

As shown in Table 5, the current status of the request sequence in the download task list is as follows:

TABLE 5

index.htm
360safe.css
frame.htm
360safe.png
product.swf

As such, a download task list has been generated. The sequence of the download task list is different from that of an original request. When downloading according to the download task list, preferentially download the text files to ensure texts to be displayed as soon as possible, and then display images and finally the flash files having relatively large sizes.

In another preferred embodiment of the present invention, at step 103, the step of, when the IE kernel browser process receives the page download request, triggering the download process to control a page download according to a preset download rule may specifically include the following sub-steps:

At sub-step S21, when the IE kernel browser process receives the page download request, send the page download request to the download process;

At sub-step S22, acquire, by the download process, file size information corresponding to the page download request; and

At sub-step S23, determine whether the file size information exceeds a preset threshold value of file size, wherein if so, employ a multi-threaded download to perform the download operation of a corresponding page; and otherwise, employ a single-threaded download to perform the download operation of the corresponding page.

The thread can be understood as a download channel. The single-threaded download means to open one download channel for a file, and the multi-threaded download means to simultaneously open a plurality of download channels for a file. Specifically, in fact, the multi-threaded download is to request various portions of a single file to the server at the same time.

This embodiment mainly involves a scheme for optimizing the download by employing the multi-threaded download for a large file in excess of a preset threshold, which is implemented during the control of the download by the download process. That is, when the browser process receives an IE download request, the download process is triggered to perform the download, and when the downloader starts downloading, the download manager may determine whether a current file size exceeds a preset threshold, wherein if so, the downloader is controlled to employ a multi-threaded download to download a file corresponding to a current page download request.

In the specific implementation, upon only once communication to the server (for example, send a standard http request), the information such as a file size and whether to support the multi-threaded download can be obtained. Usually, the multimedia type of a file such as the flash, the image may be relatively large. Therefore, a file size threshold, such as 1M, may be set as necessary. In that case, when the size of a file exceeds 1M, the multi-threaded download may be started.

In another preferred embodiment of the present invention, at step 103, the step of, when the IE kernel browser process receives the page download request, triggering the download process to control a page download according to a preset download rule may specifically include the following sub-steps:

At sub-step S31, when the IE kernel browser process receives the page download request, send the page download request to the download process; and

At sub-step S32, determine, the download process, whether the requested file has been written into a cache in advance according to the page download request, wherein if so, extract the file from the cache; if not, download a corresponding file from a server according to the page download request and write the file into the cache.

More preferably, the step of, when the IE kernel browser process receives the page download request, triggering the download process to control a page download according to a preset download rule may further include:

Before the step of extracting the file from the cache to download, query whether the time when the file was written into the cache exceeds a preset time period, and if so, download the corresponding file from the server according to the page download request and write the file into the cache.

This embodiment mainly involves a scheme for optimizing download by reading from and/or writing into the cache, which is implemented during the control of the download by the download process. That is, when the browser process receives an IE download request, trigger the download process to perform the download, and before the downloader starts downloading, the download manager may determine whether to read from the cache or to real-time download; after the downloader starts downloading, the downloaded data may be written into the cache.

In a specific application, it may be decided whether to write a file into the cache and to directly use a file that has been stored in the cache, as needed in practice. For example, if a file has just been updated in a local cache, there is no need to do a server communication in a few minutes but directly read the file from the local cache instead. Or for example, before the browser visits http://www.360.cn/index.htm, it may check whether the files are stored in the cache, wherein if not, download and store them in the cache; or if so, there is no need to do the server communication but directly use them, thereby increasing the speed of access.

More preferable action of the present embodiment in practice is in that, the operation of requesting whether the corresponding cache expires to the server is not performed every time when the IE is started, but a user is allowed to use a cache access first. After the access, check and update the cache. Of course, reference may be further made here to the last time the cache updated. If the cache has just been updated (such as a few minutes or a few hours ago), the cache may be used followed by being checked. On the other hand, if the cache was updated a few days ago, a cache check could be made at the time of being started to avoid the user from obtaining outdated contents.

Above-mentioned schemes for optimizing download can also be combined. In order for the skilled person in this art to better understand the present invention, there is provided several examples of combinations:

### Example 1

The step of, when the IE kernel browser process receives the page download request, triggering the download process to control a page download according to a preset download rule may specifically include the following sub-steps:

At sub-step S41, when the IE kernel browser process receives the page download request, send the page download request to the download process,

wherein the page download request includes URL information and the URL information includes extension name information;

At sub-step S42, add, by the download process, the page download request to the pre-generated download task list;

Sub step S43, read the extension name information of the page download request to acquire a corresponding page resource type, and in the download task list, order the page download request according to the page resource type;

At sub-step S44, sequentially process the page download request in the download task list to acquire file size information corresponding to the page download request;

At sub-step S45, determine whether the file size information exceeds a preset threshold value of file size, wherein if so, employ a multi-threaded download to perform the download operation of a corresponding page; and otherwise, employ a single-threaded download to perform the download operation of the corresponding page.

### Example 2

The step of, when the IE kernel browser process receives the page download request, triggering the download process to control a page download according to a preset download rule may specifically include the following sub-steps:

At sub-step S51, when the IE kernel browser process receives the page download request, send the page download request to the download process, wherein the page download request includes URL information and the URL information includes extension name information;

At sub-step S52, determines, by the download process, whether the requested file has been written in a cache in advance according to the page download request, wherein if so, query whether the time when the file was written in the cache exceeds a preset time period, if yes, download a corresponding file from a server according to the page download request and write the file into the cache and if not, extract the file from the cache;

At sub-step S53, if the file corresponding to the page download request has not been written into the cache in advance, download a corresponding file from a server according to the page download request and write file into the cache.

Herein, the step of downloading a corresponding file from a server according to the page download request may include:

At sub-step S54, download the corresponding file from the server according to the page download request;

At sub-step S55, read the extension name information of the page download request to acquire a corresponding page resource type, and in the download task list, order the page download request according to the page resource type; and

At sub-step S56, sequentially process the page download request in the download task list to execute the corresponding page download operation.

### Example 3

The step of, when the IE kernel browser process receives IE download request, triggering the download process to control a page download according to a preset download rule may specifically include the following sub-steps:

At sub-step S61, when the IE kernel browser process receives the page download request, send the page download request to the download process;

At sub-step S62, determine, by the download process, whether the requested file has been written into a cache in advance according to the page download request, wherein if so, query whether the time when the file was written into the cache exceeds a preset time period, if yes, download the corresponding file from a server according to the page download request and write the file into the cache and if not, extract the file from the cache; and

At sub-step S63, if the file corresponding to the page download request has not been written into the cache in advance, download a corresponding file from a server according to the page download request and write the file into the cache.

Herein, the step of downloading a corresponding file from a server according to the page download request may include:

At sub-step S64, acquire, by the download process, file size information corresponding to the page download request;

At sub-step S65, determine whether the file size information exceeds a preset threshold value of file size, wherein if so, employ a multi-threaded download to perform the download operation of a corresponding page; and otherwise, employ a single-threaded download to perform the download operation of the corresponding page.

### Example 4

The step of, when the IE kernel browser process receives the page download request, triggering the download process to control a page download according to a preset download rule may specifically include the following sub-steps:

At sub-step S71, when the IE kernel browser process receives the page download request, send the page download request to the download process, wherein the page download request includes URL information and the URL information includes extension name information;

At sub-step S72, determine, by the download process, whether the requested file has been written into a cache in advance according to the page download request, wherein if so, query whether the time when the file was written into the cache exceeds a preset time period, if yes, download a corresponding file from a server according to the page download request and write the file into the cache and if not, extract the file from the cache; and

At sub-step S73, if the file corresponding to the page download request has not been written into the cache in advance, download the corresponding file from the server according to the page download request and write the file into the cache.

Herein, the step of downloading the corresponding file from the server according to the page download request may include:

At sub-step S74, add, by the download process, the page download request to a pre-generated download task list;

At sub-step S75, read the extension name information of the page download request to acquire a corresponding page resource type, and in the download task list, order the page download request according to the page resource type;

At sub-step S76, sequentially process the page download request in the download task list to acquire file size information corresponding to the page download request; and

At sub-step S77, determine whether the file size information exceeds a preset threshold value of file size, wherein if so, employ a multi-threaded download to perform the download operation of the corresponding page; and otherwise, employ a single-threaded download to perform the download operation of the corresponding page.

Of course, above-mentioned schemes for optimizing the download of various embodiments and combinations thereof are used only for illustration. It is feasible for a person skilled in the art to employ other optimized download methods, and thus there is no need for the present invention to limit it.

In a specific implementation, the embodiments of the present invention may also comprise the following steps:

At step 104, the IE kernel browser process performs parsing, executing and/or rendering operations on the downloaded page data based on the download status information.

When the download operation is completed by the download process, return the downloaded data to the IE kernel to continue the operations of parsing, executing and rendering.

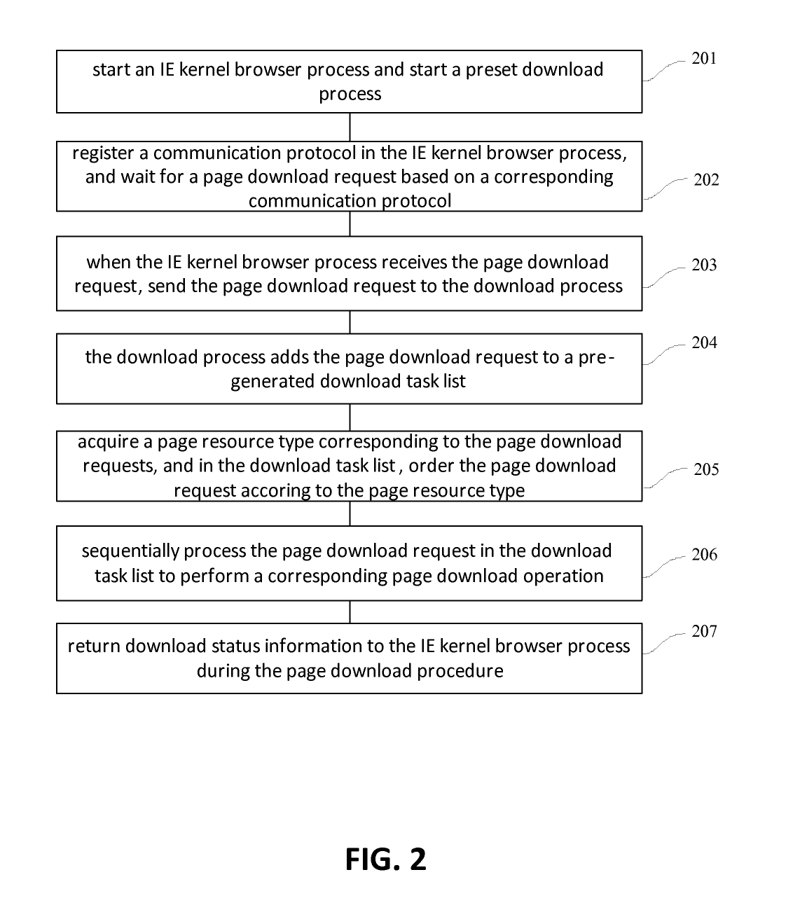

FIG. 2 is a flowchart schematically illustrating a method of webpage download control for an IE kernel browser according to a second method embodiment of the present invention. Referring to FIG. 2, the method may specifically include the following steps:

At step 201, start an IE kernel browser process and start a preset download process;

In the embodiment of the present invention, the IE kernel browser process refers to a browser process employing the kernel of an IE (Internet Explorer) browser. In the prior art, the browser kernel is responsible for downloading, parsing, executing and rendering a webpage; while in this embodiment, the kernel of an IE browser is arranged to perform the operations of parsing, executing and rendering only, and the download operation may be implemented by the preset download process.

The download process can be understood as an additional process of the IE kernel browser, which is a process specially set for the download operation. That is, the download process is specially set to download, rather than do other operations. As a specific example implemented by the embodiment of the present invention, the interior of the download process may use WinHTTP (Microsoft Windows HTTP Services, which provide developers with an HTTP client application programming interface, through which a request may be sent to other HTTP servers by an HTTP protocol) to implement a downloader and a download manager. It means that the download process may include a download manager and downloaders, wherein the download manager can be set to control the page download according to a preset download rule (for example, to order and optimize requests for download a resource); the downloaders can be set to implement the specific download operation and report a download state (i.e., download status information) to the IE kernel browser process through the download manager. In practice, the download process, like a service, is waiting to be called at any time after being started.

In the embodiments of the invention, the download process may be started when the IE kernel browser process is started, or in other words, the activation of the IE kernel browser process may trigger the download process to ensure the normal exhibition of a page in the browser.

At step 202, register a communication protocol in the IE kernel browser process, and wait for a page download request based on a corresponding communication protocol;

In the specific implementation, the step of registering a communication protocol in the IE kernel browser process may be to register the communication protocol in the IE kernel browser process by using the RegisterNameSpace method of an IInternetSession interface. The communication protocol may include an http protocol, an https protocol, a mailto protocol, an FTP protocol and so on.

Specifically, the RegisterNameSpace method of the IInternetSession interface requests a fixed format interface, and after registering the communication protocol in the IE kernel browser process by using this method, all the page download requests employing the corresponding communication protocol may be sent to a pre-set shell interface. That is, when there is any page download request employing the corresponding communication protocol (such as the http protocol, the https protocol, the mailto protocol and the FTP protocol), the IE kernel may inform or call the preset shell interface.

At step 203, when the IE kernel browser process receives the page download request, send the page download request to the download process;

At step 204, add, by the download process, the page download request to a pre-generated download task list;

At step 205, acquired page resource type corresponding to the page download request, and in the download task list, order the page download request according to the page resource type;

In practice, the page download request may include URL information and the URL information may include the extension name information. In this case, the page resource type corresponding to the page download request can be acquired by reading the extension name information.

At step 206, sequentially process the page download request in the download task list to perform a corresponding page download operation;

At step 207, return download status information to the IE kernel browser process during the page download procedure.

In the specific implementation, when the IE kernel calls a Start method of the IInternetProtocol interface provided in the procedure of registering the communication protocol, the page download request may be sent to the download process through a cross-process communication and return an operator E_PENDING to inform the IE kernel of the operation being executed.

When data is downloaded, the download process may inform the IE kernel browser process which initiates the download, and then the IE kernel browser process may call a corresponding method of the IInternetProtocolSink interface provided by the IE kernel to inform the IE kernel of the download status information such as download progress and downloaded data.

More specifically, the cross-process communication means to transmit a request of a process to another process. In the present embodiment, it means to transmit the page download request of the IE kernel browser process to the download process, and during the download procedure, the download status information such as the download progress and the downloaded data is real-time reported to the IE kernel. The cross-process communication can use a Windows message mechanism and perform data transmission with the kernel object cooperated. For example, after the http protocol is registered in the IE browser process, once the page download request based on http protocol is presented, it will be sent to a preset browser shell. When the IE kernel calls a shell, it may transmit the corresponding information of the page download request thereto, and the shell may pack the information (store it into a data block that mainly includes url, refresh, cookie, etc.) and send this data block to the download process via a standard channel communication provided by a Windows system. A Windows message sent to the browser process during the download procedure mainly inform the browser of the current download progress.

In short, the cross-process communication refers to two sides. Firstly, when the IE kernel browser process receives a page download request, it may inform the download process of the file to be downloaded through the cross-process communication. On the other hand, when the download request is being executed, the download process may send a message to the IE kernel browser process to inform it of the download status information such as the download progress and the downloaded data.

This embodiment mainly refers to a scheme for optimizing the download by ordering a resource, which is implemented during the control of the download by the download process. That is, when the browser process receives the IE download request, trigger the download process to perform the download, and before starting the download by the downloader, the download manager may order the resource corresponding to the download request.

In practical applications, the type of a text file (such as html, css, js and the like) may be downloaded preferentially, and the type of a multimedia file (such as image, flash and other large-sized files) may be downloaded later because the exhibition of the webpage is not dependent on them. A download task list may be included in the download manager of the download process. The location where a new added download task is to be positioned in the list may be determined according to a priority. For example, since the type of the text file such as html, css and js is necessary when opening a webpage, an is positioned to the top of the list, while other multimedia type of a file such as an image and a flash are located to the end of the list. The downloader may continuously acquire tasks from the head of list to start the download. This may realize the ordering of the resource.

In practice, each of page download requests corresponds to a download task, and each of download tasks corresponds to a page resource type.

In a preferred embodiment of the present invention, at step 206, the step of performing the corresponding page download operation may include the following sub-steps:

At sub-step S21, acquire file size information corresponding to the page download request;

At sub-step S22, determine whether the file size information exceeds a preset threshold value of file size; if yes, go to sub-step S23, and if not, go to sub-step S24;

At sub-step S23, employ a multi-threaded download to perform the download operation of a corresponding page; and

At sub-step S24, employ a single-threaded download to perform the download operation of the corresponding pages.

The thread can be understood as a download channel. The single-threaded download means to open one download channel for a file, and the multi-threaded download means to simultaneously open a plurality of download channels for a file. Specifically, in fact, the multi-threaded download is to request various portions of a single file to the server at the same time.

This embodiment mainly involves a scheme for optimizing the download by employing the multi-threaded download for a large file in excess of a preset threshold, which is implemented during the control of the download by the download process. That is, when the browser process receives an IE download request, the download process is triggered to perform the download, and when the downloader starts downloading, the download manager may determine whether the current file size exceeds a preset threshold, wherein if so, the downloader is controlled to employ the multi-threaded download to download a file corresponding to a current page download request.

In the specific implementation, upon only once communication to the server (for example, send a standard http request), the information such as the file size and whether to support the multi-threaded download can be obtained. Usually, the multimedia type of the file such as the flash, the image and the like may be relatively large. Therefore, a file size threshold, such as 1M, may be set as necessary. In that case, when the size of a file exceeds 1M, the multi-threaded download may be started.

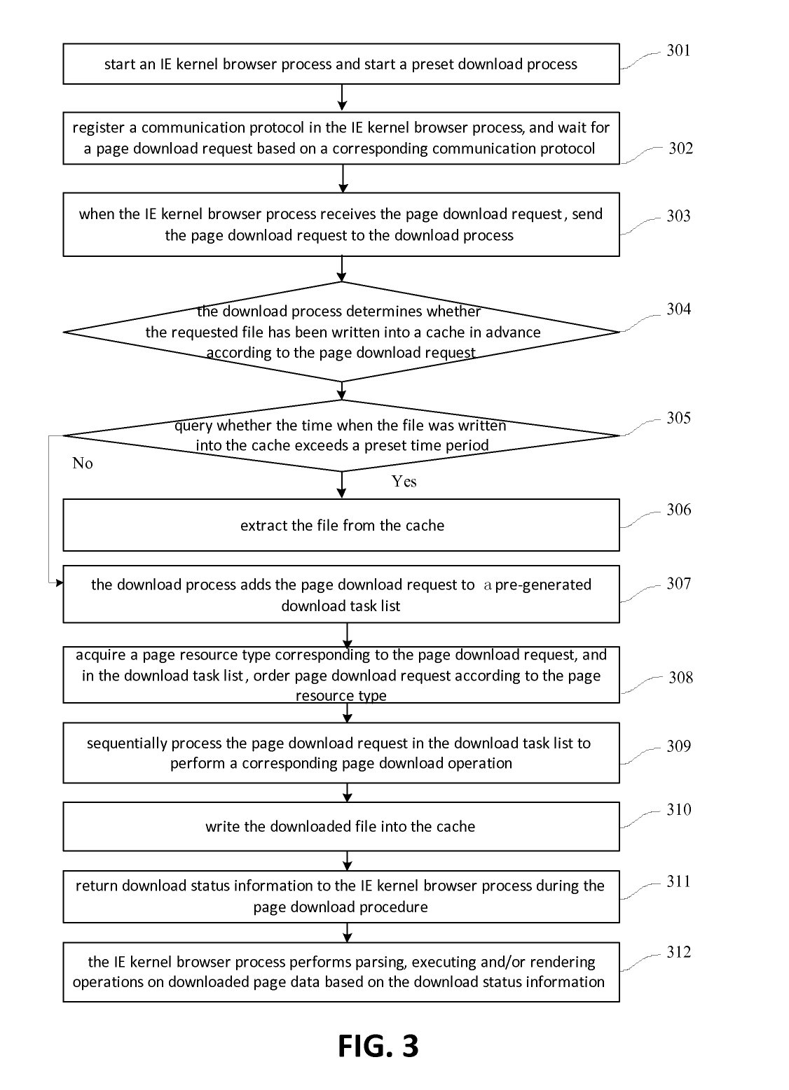

FIG. 3 is a flowchart schematically illustrating a method of webpage download control for an IE kernel browser according to a third method embodiment of the present invention. Referring to FIG. 3, the method may specifically include the following steps:

At step 301, start an IE kernel browser process and simultaneously start a preset download process;

At step 302, register a communication protocol in the IE kernel browser process, and wait for a page download request based on a corresponding communication protocol;

At step 303, when the IE kernel browser process receives the page download request, send the page download request to the download process;

At step 304, determine, by the download process, whether the requested file has been written into a cache in advance according to the page download request, wherein if yes, go to step 305; otherwise go to step 307;

At step 305, query whether the time when the file was written into the cache exceeds a preset time period, wherein if not, go to step 306; or if yes, go to step 307;

At step 306, extract the file from the cache;

At step 307, add, by the download process, the page download request to a pre-generated download task list;

At step 308, acquire a page resource type corresponding to the page download request, and in the download task list, order the page download request according to the page resource type;

At step 309, sequentially process the page download request in the download task list to perform a corresponding page download operation;

At step 310, write the downloaded file into the cache.

At step 311, return download status information to the IE kernel browser process during the page download procedure.

This embodiment mainly involves a scheme for optimizing download by reading from and/or writing into the cache, which is implemented during the control of the download by the download process. That is, when the browser process receives an IE download request, trigger the download process to perform the download, and before the downloader starts downloading, the download manager may determine whether to read from the cache or to real-time download; after the downloader starts downloading, the downloaded data may be written into the cache.

In specific applications, it may be decided whether to write a file into the cache and to directly use a file that has been stored in the cache, as needed in practice. For example, if a file has just been updated in a local cache, there is no need to do a server communication in a few minutes but directly read the file from the local cache instead. Or for example, before the browser visits http://www.360.cn/index.htm, it may check whether the files are stored in the cache, wherein if not, download and store them in the cache; or if so, there is no need to do the server communication but directly use them, thereby increasing the speed of access.

More preferable action of the present embodiment in practice is in that, the operation of requesting whether the corresponding cache expires to the server is not performed every time when the IE starts, but a user is allowed to use the cache access first. After the access, check and update the cache. Of course, reference may be further made here to the last time the cache updated. If the cache has just been updated (such as a few minutes or a few hours ago), the cache may be used followed by being checked. On the other hand, if the cache was updated a few days ago, a cache check could be made at the time of starting to avoid the user from obtaining outdated contents.

In a specific implementation, the embodiments of the present invention may also comprise the following step:

At step 312, the IE kernel browser process performs parsing, executing and/or rendering operations on the downloaded page data based on the download status information.

When the download operation is completed by the download process, return the downloaded data to the IE kernel to continue the operations of parsing, executing and rendering.

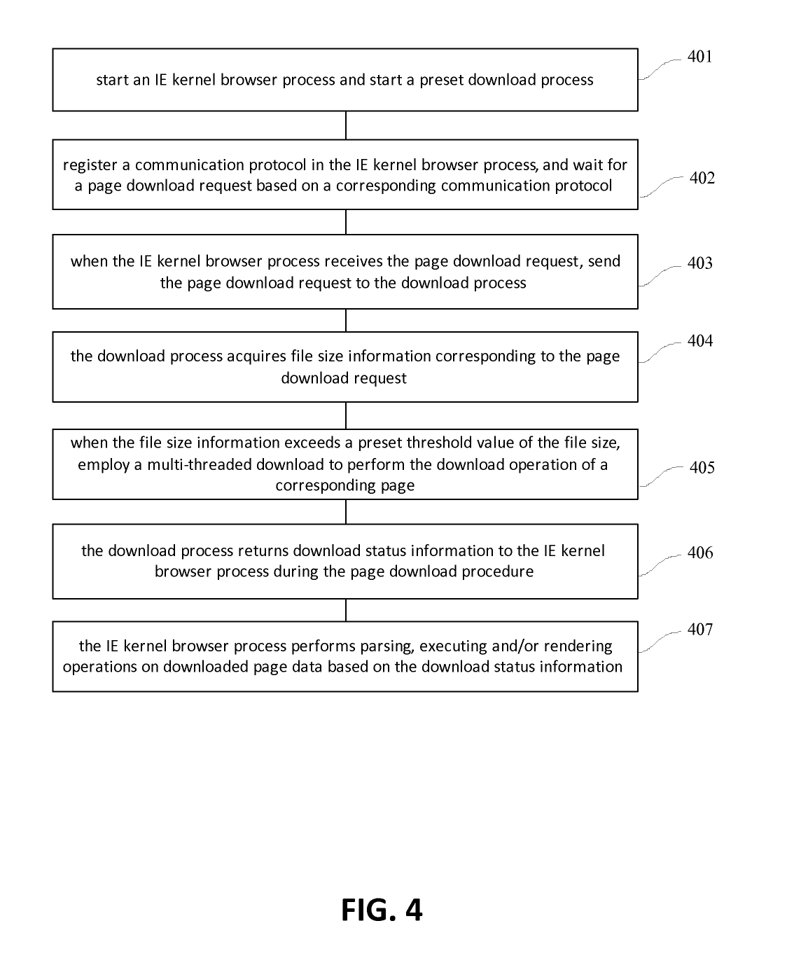

FIG. 4 is a flowchart schematically illustrating a method of webpage download control for an IE kernel browser according to a fourth method embodiment of the present invention. Referring to FIG. 4, the method may specifically include the following steps:

At step 401, start an IE kernel browser process and start a preset download process;

In the embodiment of the present invention, the IE kernel browser process refers to a browser process employing the kernel of an IE (Internet Explorer) browser. In the prior art, the browser kernel is responsible for downloading, parsing, executing and rendering a webpage; while in this embodiment, the kernel of the IE browser is arranged to complete the operations of parsing, executing and rendering only, and the download operation may be implemented by the preset download process.

The download process can be understood as an additional process of the IE kernel browser, which is a process specially set for the download operation. That is, the download process is specially set to download, rather than do other operations. As a specific example implemented by the embodiments of the present invention, the interior of the download process may use WinHTTP (Microsoft Windows HTTP Services, which provides a developer with an HTTP client application programming interface (API), through which a request may be sent to other HTTP servers by an HTTP protocol) to implement a downloader and a download manager. It means that the download process may include the download manager and the downloader, wherein the download manager can be set to control the page download according to a preset download rule (for example, to order and optimize requests for download resources); the downloader can be set to implement the specific download operation and report a download state (i.e., download status information) to the IE kernel browser process through the download manager. In practice, the download process, like a service, is waiting to be called at any time after being started.

In the embodiments of the invention, the download process may be started when the IE kernel browser process is started to ensure the normal exhibition of a page in the browser.

At step 402, register a communication protocol in the IE kernel browser process, and wait for a page download request based on a corresponding communication protocol;

In the specific implementation, the step of registering a communication protocol in the IE kernel browser process may be to register the communication protocol in the IE kernel browser process by using the RegisterNameSpace method of an IInternetSession interface. The communication protocol may include an http protocol, an https protocol, a mailto protocol an FTP protocol and so on.

Specifically, the RegisterNameSpace method of the IInternetSession interface requests a fixed format interface, and after registering the communication protocol in the IE kernel browser process by using this method, all the page download requests employing the corresponding communication protocol may be sent to a pre-set shell interface. That is, when there is any page download request employing the corresponding communication protocol (such as the http protocol, and the https protocol), the IE kernel may inform or call the preset shell interface.

At step 403, when the IE kernel browser process receives the page download request, send the page download request to the download process;

At step 404, acquire, by the download process, file size information corresponding to the page download request;

At step 405, when the file size information exceeds a preset threshold value of the file size, employ a multi-threaded download to perform the download operation of a corresponding page;

At step 406, return, by the download process, download status information to the IE kernel browser process during the page download procedure.

In a preferred embodiment of the embodiments of the present invention may also include the following step:

when the file size information is equal to or less than the preset threshold value of the file size, employ a single-threaded download to perform the download operation of the corresponding page.

In the specific implementation, when the IE kernel calls a Start method of the IInternetProtocol interface provided in the procedure of registering the communication protocol, the page download request may be sent to the download process through the cross-process communication and return an operator E_PENDING to inform the IE kernel of the operation being executed. When data is downloaded, the download process may inform the IE kernel browser process which initiates the download, and then the IE kernel browser process may call a corresponding method of the IInternetProtocolSink interface provided by the IE kernel to inform the IE kernel of the download status information such as download progress and downloaded data.

More specifically, the cross-process communication means to transmit a request of a process to another process. In the present embodiment, it means to transmit the page download request of the IE kernel browser process to the download process, and during the download procedure, the download status information such as download progress and downloaded data is real-time reported to the IE kernel. The cross-process communication can use a Windows message mechanism and perform data transmission with the kernel object cooperated. For example, after the http protocol is registered in the IE browser process, once the page download request based on the http protocol is presented, it will be sent to a preset browser shell. When the IE kernel calls the shell, it may transmit the corresponding information of the page download request thereto, and the shell may pack the information (store it into a data block that mainly includes url, refresh, cookie, etc.) and send this data block to the download process via a standard channel communication provided by a Windows system. A Windows message sent to the browser process during the download procedure mainly inform the browser of the current download progress.

In short, the cross-process communication refers to two sides. Firstly, when the IE kernel browser process receives a page download request, it may inform the download process of files to be downloaded through the cross-process communication. On the other hand, when the download request is being executed, the download process may send a message to the IE kernel browser process to inform it of the download status information such as the download progress and the downloaded data.

This embodiment of the present invention mainly involves a scheme for optimizing the download by employing the multi-threaded download for a large file in excess of a preset threshold, which is implemented during the control of the download by the download process. That is, when the browser process receives an IE download request, trigger the download process to perform the download, and when the downloader starts downloading, the download manager may determine whether a current file size exceeds a preset threshold, wherein if so, the downloader is controlled to employ the multi-threaded download to download a file corresponding to current page download request.

The thread can be understood as a download channel. The single-threaded download means to open one download channel for a file, and the multi-threaded download means to simultaneously open a plurality of download channels for a file. Specifically, in fact, the multi-threaded download is to request various portions of a single file to the server at the same time.

In the specific implementation, upon only once communication to the server (for example, send a standard http request), the information such as the file size and whether to support the multi-threaded download can be obtained. Usually, the multimedia type of files such as the flash and the image may be relatively large. Therefore, a file size threshold, such as 1M, may be set as necessary. In that case, when the size of a file exceeds 1M, the multi-threaded download may be started.

In the specific implementation, the embodiments of the present invention may also comprise the following step:

At step 407, the IE kernel browser process performs parsing, executing and/or rendering operations on the downloaded page data based on the download status information.

When the download operation is completed by the download process, return the downloaded data to the IE kernel to continue the operations of parsing, executing and rendering.

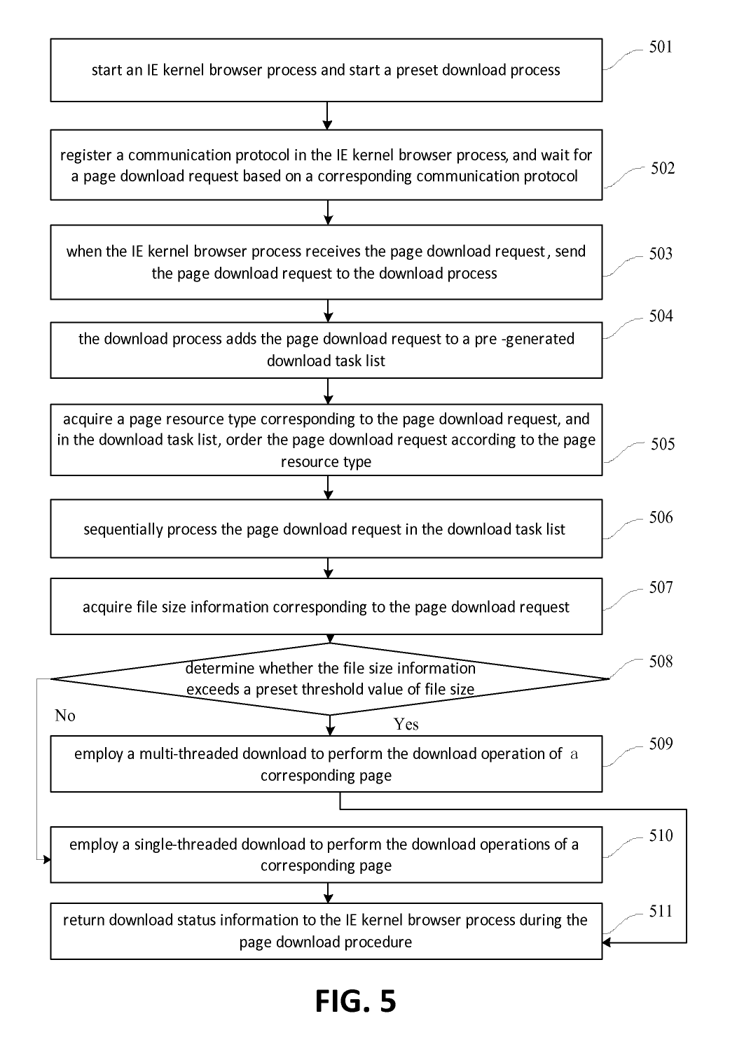

FIG. 5 is a flowchart schematically illustrating a method of webpage download control for an IE kernel browser according to a fifth method embodiment of the present invention. Referring to FIG. 5, the method may specifically include the following steps:

At step 501, start an IE kernel browser process and start a preset download process;

At step 502, register a communication protocol in the IE kernel browser process, and wait for a page download request based on a corresponding communication protocol;

At step 503, when the IE kernel browser process receives the page download request, send the page download request to the download process;

At step 504, add, by the download process, the page download request to a pre-generated download task list;

At step 505, acquire a page resource type corresponding to the page download request, and in the download task list, order the page download request according to the page resource type;

In practice, the page download request may include URL information and the URL information may include extension name information. In this case, page resource type corresponding to the page download request can be acquired by reading the extension name information.

At step 506, sequentially process the page download request in the download task list;

At step 507, acquire file size information corresponding to the page download request;

At step 508, determine whether the file size information exceeds a preset threshold value of file size; if yes, go to step 509, and if not, go to step 510;

At step 509, employ a multi-threaded download to perform the download operation of a corresponding page and then go to step 511;

At step 510, employ a single-threaded download to perform the download operation of the corresponding page and then go to step 511;

At step 511, return download status information to the IE kernel browser process during the page download procedure.

This embodiment mainly involves a scheme for optimizing the download by employing the multi-threaded download and ordering a resource, which is implemented during the control of the download by the download process. That is, when the browser process receives an IE download request, trigger the download process to perform the download, and before the downloader starts downloading, the download manager may order the resource corresponding to the download request and determine whether the current file size exceeds the preset threshold, wherein if so, the downloader is controlled to employ a multi-threaded download to download the file corresponding to current page download request.

In practical applications, the type of text file (such as html, css, js and the like) may be downloaded preferentially, and the type of multimedia file (such as image, flash and other large-sized files) may be downloaded later because the exhibition of the webpage is not dependent on them. A download task list may be included in the download manager of the download process. The location where a new added download task is to be positioned in the list may be determined according to a priority. For example, since the type of text file such as html, css and js is necessary when opening a webpage, they are positioned to the top of the list, while other multimedia type of files such as the image and the flash are located to the end of the list. The downloader may continuously acquire tasks from the head of list to start the download. This may realize the ordering of the resource.

In practice, each of page download requests corresponds to a download task, and each of download tasks corresponds to a page resource type.

When processing is provided to a large-sized file (such as, the last file, product.swf) in the download task list, it may be determined whether its size exceeds a preset threshold (such as 1M). If so, the multi-threaded download may be started. The multi-threaded download means to simultaneously open a plurality of download channels for a single file. Specifically, in fact, the multi-threaded download is to request various portions of a single file to the server at the same time.

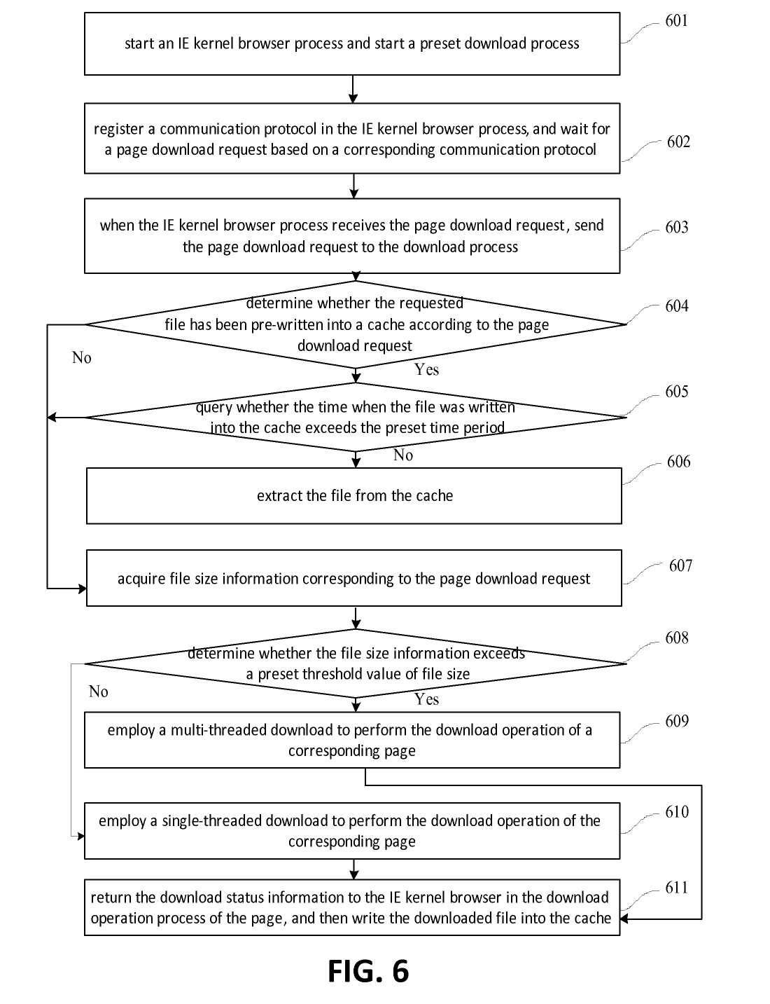

FIG. 6 is a flowchart schematically illustrating a method of webpage download control for an IE kernel browser according to a sixth method embodiment of the present invention. Referring to FIG. 6, the method may specifically include the following steps:

At step 601, start an IE kernel browser process and start a preset download process;

At step 602, register a communication protocol in the IE kernel browser process, and wait for a page download request based on a corresponding communication protocol;

At step 603, when the IE kernel browser process receives the page download request, send the page download request to the download process;

At step 604, determine whether the requested file has been pre-written into a cache according to the page download request, and if so, go to step 605; otherwise, go to step 607;

At step 605, query whether the time when the file was written into the cache exceeds a preset time period, and if so, go to step 607; otherwise, step 606;

At step 606, extract the file from the cache;

At step 607, acquire file size information corresponding to the page download request;

At step 608, determine whether the file size information exceeds a preset threshold value of file size; and if so, starts executing step 609; otherwise, go to step 610;

At step 609, employ a multi-threaded download to perform the download operation of a corresponding page; go to step 611;

At step 610, employ a single-threaded download to perform the download operation of the corresponding pages; go to step 611;

At step 611, return the download status information to the IE kernel browser in the download operation process of the page, and then write the downloaded file into the cache,

This embodiment mainly involves a scheme for optimizing download by employing the multi-threaded download and reading from and/or writing into the cache, which is implemented during the control of the download by the download process. That is, when the browser process receives an IE download request, trigger the download process to perform the download, and before the downloader starts downloading, the download manager may determine whether to read from the cache or to real-time download; and determines whether the current file size exceeds the preset threshold, wherein if so, the downloader is controlled to employ the multi-threaded download to download a file corresponding to a current page download request. After the downloader starts downloading, the downloaded data may be written into the cache.

In a specific application, it may be decided whether to write a file into the cache and to directly use a file that has been stored in the cache, as needed in practice. For example, if a file has just been updated in a local cache, there is no need to do a server communication in a few minutes but directly read the file from the local cache instead. Or for example, before the browser visits http://www.360.cn/index.htm, it may check whether the files are stored in the cache, wherein if not, download and store them in the cache; or if so, there is no need to do the server communication but directly use them, thereby increasing the speed of access.

More preferable action of the present embodiment in practice is in that, the operation of requesting whether the corresponding cache expires to the server is not performed every time the IE starts, but users are allowed to use the cache access first. After the access, check and update the cache. Of course, reference may be further made here to the last time the cache updated. If the cache has just been updated (such as a few minutes or a few hours ago), the cache may be used followed by being checked. On the other hand, if the cache was updated a few days ago, a cache check could be made at the time of starting to avoid the user from obtaining outdated contents.

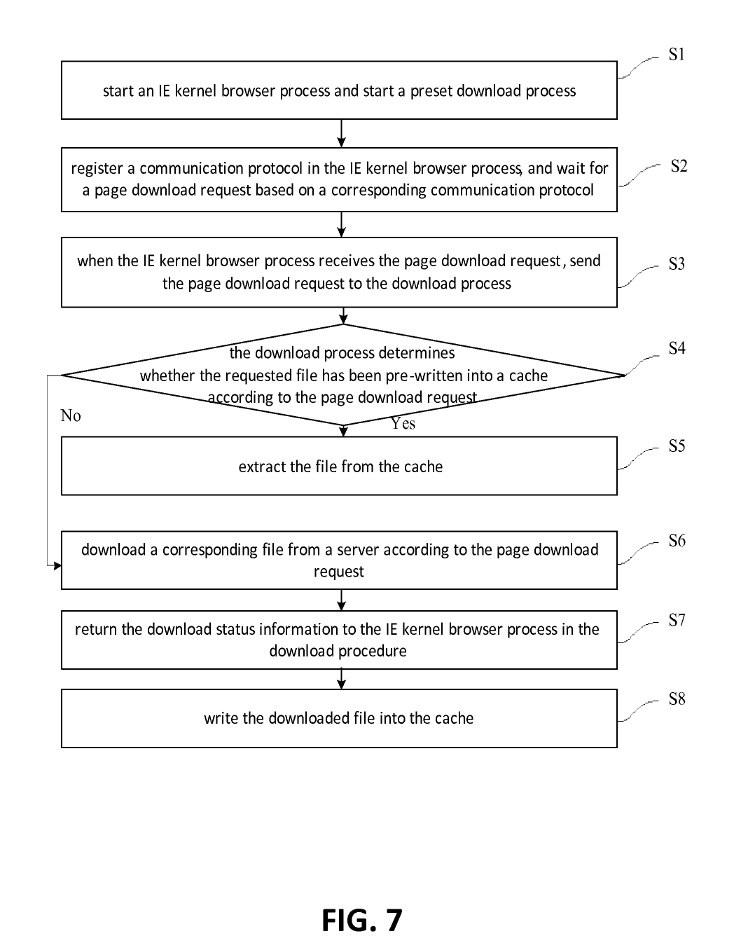

FIG. 7 is a flowchart schematically illustrating a method of webpage download control for an IE kernel browser according to embodiments of the present invention, and the method may specifically include the following steps:

At step S1, start an IE kernel browser process and start a preset download process;

In the embodiment of the present invention, the IE kernel browser process refers to a browser process employing the kernel of an IE (Internet Explorer) browser. In the prior art, the browser kernel is responsible for downloading, parsing, executing and rendering a webpage; while in this embodiment, the kernel of an IE browser is arranged to complete the operations of parsing, executing and rendering only, and the download operation may be implemented by the preset download process.

The download process can be understood as an additional process of the IE kernel browser, which is a process specially set for the download operation. That is, the download process is specially set to download, rather than do other operations. As a specific example implemented by the embodiments of the present invention, the interior of the download process may use WinHTTP (Microsoft Windows HTTP Services, which provide a developer with an HTTP client application programming interface (API), through which a request may be sent to other HTTP servers by an HTTP protocol) to implement a downloader and a download manager. It means that the download process may include the download manager and the downloader, wherein the download manager can be set to control the page download according to a preset download rule (for example, to order and optimize requests for download resources); the downloader can be set to implement the specific download operation and report the download state (i.e., download status information) to the IE kernel browser process through the download manager. In practice, the download process, like a service, is waiting to be called at any time after being started.

In the embodiment of the invention, the download process may be started when the IE kernel browser process is started to ensure the normal exhibition of a page in the browser.

At step S2, register a communication protocol in the IE kernel browser process, and wait for a page download request based on a corresponding communication protocol;

In a specific implementation, the step of registering a communication protocol in the IE kernel browser process may be to register the communication protocol in the IE kernel browser process by using the RegisterNameSpace method of an IInternetSession interface. The communication protocol may include the http protocol, an https protocol, a mailto protocol, an FTP protocol and so on.

Specifically, the RegisterNameSpace method of the IInternetSession interface requests a fixed format interface, and after registering the communication protocol in the IE kernel browser process by using this method, all the page download requests employing the corresponding communication protocol may be sent to a pre-set shell interface. That is, when there is any page download request employing the corresponding communication protocol (such as the http protocol and the https protocol), the IE kernel may inform or call the preset shell interface.

At step S3, when the IE kernel browser process receives the page download request, send the page download request to the download process;

At step S4: determines, by the download process, whether the requested file has been pre-written into a cache according to the page download request; if yes, execute step S5; otherwise, execute steps S6, S7, and S8;

At step S5: extract the file from the cache;

At step S6: download a corresponding file from a server according to the page download request;

At step S7: return the download status information to the IE kernel browser process in the download procedure;

At step S8: write the downloaded file into the cache.

In the specific implementation, when the IE kernel calls a Start method of the IInternetProtocol interface provided in the procedure of registering the communication protocol, the page download request may be sent to the download process through a cross-process communication and return an operator E_PENDING to inform the IE kernel of the operation being executed. When data is downloaded, the download process may inform the IE kernel browser process which initiates the download, and then the IE kernel browser process may call a corresponding method of the IInternetProtocolSink interface provided by the IE kernel to inform the IE kernel of the download status information such as download progress and downloaded data.

More specifically, the cross-process communication means to transmit a request of a process to another process. In the present embodiment, it means to transmit the page download request of the IE kernel browser process to the download process, and during the download procedure, real-time report the download status information such as the download progress and the downloaded data to the IE kernel. The cross-process communication can use a Windows message mechanism and perform data transmission with the kernel object cooperated. For example, after the http protocol is registered in the IE browser process, once the page download request based on the http protocol is presented, it will be sent to a preset browser shell. When the IE kernel calls the shell, it may transmit the corresponding information of the page download request thereto, and the shell may pack the information (store it into a data block that mainly includes url, refresh, cookie, etc.) and send this data block to the download process via a standard channel communication provided by a Windows system. A Windows message sent to the browser process during the download procedure mainly inform the browser of the current download progress.

In short, the cross-process communication refers to two sides. Firstly, when the IE kernel browser process receives a page download request, it may inform the download process of file to be downloaded through the cross-process communication. On the other hand, when the download request is being executed, the download process may send a message to the IE kernel browser process to inform it of the download status information such as the download progress and the downloaded data.

This embodiment mainly involves a scheme for optimizing download by reading from and/or writing into the cache, which is implemented during the control of the download by the download process. That is, when the browser process receives an IE download request, trigger the download process to perform the download, and before the downloader starts downloading, the download manager may determine whether to read from the cache or to real-time download; after the downloader starts downloading, the downloaded data may be written into the cache.

In a specific application, it may be decided whether to write a file into the cache and to directly use a file that has been stored in the cache, as needed in practice. For example, if a file has just been updated in a local cache, there is no need to do a server communication in a few minutes but directly read the file from the local cache instead. Or for example, before the browser visits http://www.360.cn/index.htm, it may check whether the files are stored in the cache, wherein if not, download and store them in the cache; or if so, there is no need to do the server communication but directly use them, thereby increasing the speed of access.

In a specific implementation, before step S5, it may also include the following steps:

At step S41, query whether the time when the file was written into the cache exceeds a preset time period, and if so, go to steps S6, S7 and S8; otherwise, execute step S5.

More preferable action of the present embodiment in practice is in that, the operation of requesting whether the corresponding cache expires to the server is not performed every time when the IE starts, but a user is allowed to use the cache access first. After the access, check and update the cache. Of course, reference may be further made here to the last time the cache updated. If the cache has just been updated (such as a few minutes or a few hours ago), the cache may be used followed by being checked. On the other hand, if the cache was updated a few days ago, a cache check could be made at the time of starting to avoid the user from obtaining outdated contents.

In the specific implementation, the embodiments of the present invention may also comprise the following steps:

At step S9, perform, by the IE kernel browser process, parsing, executing and/or rendering operations on the downloaded page data based on the download status information.

When the download operation is completed by the download process, return the downloaded data to the IE kernel to continue the operations of parsing, executing and rendering.

In a preferred embodiment of the present invention, the step S6 may specifically also include the following sub-steps:

At sub-step S11, add, by the download process, the page download request to a pre-generated download task list;

At sub-step S12, acquire a page resource type corresponding to the page download request, and in the download task list, order the page download request according to the page resource type; and

At sub-step S13, sequentially process the page download request in the download task list to execute a corresponding page download operation.

In practice, the page download request may include URL information and the URL information may include extension name information. In this case, the page resource type corresponding to the page download request can be acquired by reading the extension name information.

This embodiment mainly refers to a scheme for optimizing the download by ordering the resources, which is implemented during the control of download by the download process. That is, when the browser process receives the IE download request, trigger the download process to perform the download, and before starting the download by the downloader, the download manager may order the resource corresponding to the download request.

In a practical application, the type of text file (such as html, css, js and the like) may be downloaded preferentially, and the type of multimedia file (such as image, flash and other large-sized files) may be downloaded later because the exhibition of the webpage is not dependent on them. A download task list may be included in the download manager of the download process. The location where a new added download task is to be positioned in the list may be determined according to a priority. For example, since the type of text file such as html, css and js is necessary when opening a webpage, they are positioned to the top of the list, while other multimedia type of files such as the image and the flash are located to the end of the list. The downloader may continuously acquire tasks from the head of list to start the download. This may realize the ordering of the resource.

In practice, each of page download requests corresponds to a download task, and each of download tasks corresponds to a page resource type.

More preferably, in the step S13, the steps of sequentially processing the page download request in the download task list, and implementing the corresponding page download operation also includes:

At sub-step S13-1, acquire, by the download process, file size information corresponding to the page download request;

At sub-step S13-2, determine whether the file size information exceeds a preset threshold value of file size, wherein if so, employ a multi-threaded download to perform the download operation of a corresponding page; and otherwise, employ a single-threaded download to perform the download operation of the corresponding page.

The thread can be understood as a download channel. The single-threaded download means to open one download channel for a file, and the multi-threaded download means to simultaneously open a plurality of download channels for a file. Specifically, in fact, the multi-threaded download is to request various portions of a single file to the server at the same time.

This embodiment mainly involves a scheme for optimizing the download by employing the multi-threaded download for a large file in excess of the preset threshold, which is implemented during the control of the download by the download process. That is, when the browser process receives an IE download request, trigger the download process to perform the download, and when the downloader starts downloading, the download manager may determine whether the current file size exceeds the preset threshold, wherein if so, the downloader is controlled to employ the multi-threaded download to download the file corresponding to a current page download request.

In the specific implementation, upon only once communication to the server (for example, send a standard http request), the information such as the file size and whether to support multi-threaded download can be obtained. Usually, the multimedia type of the file such as the flash, the image and the like may be relatively large. Therefore, a file size threshold, such as 1M, may be set as necessary. In that case, when the size of a file exceeds 1M, the multi-threaded download may be started.

It should be explained that, for the sake of simplicity of description, the method embodiments are described as combination of a series of actions, whereas a person skilled in the art should be aware that the present invention is not limited by the described action sequence, and certain steps may be performed in other orders or simultaneously according to the present invention. Secondly, a person skilled in the art should be aware that the embodiments described in the specification are all preferred embodiments, while the involved actions and modules are not certainly necessary in the present invention.

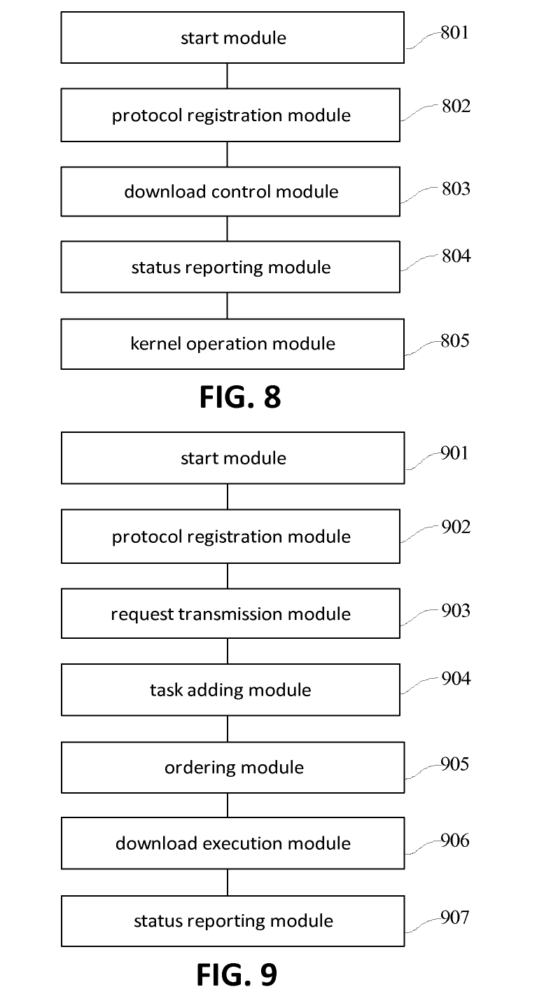

FIG. 8 is a block diagram schematically illustrating a system of webpage download control for an IE kernel browser according to a first system embodiment of the present invention, and specifically it may include the following modules:

a start module 801, configured to start an IE kernel browser process and start a preset download process;

a protocol registration module 802, configured to register a communication protocol in the IE kernel browser process, and wait for a page download request based on a corresponding communication protocol;

a download control module 803, configured to trigger the download process to control a page download according to a preset download rule, when the IE kernel browser process receives a page download request; and

a status reporting module 804, configured to return download status information to the IE kernel browser process during the page download procedure.

In the specific application according to the embodiments of the present invention, the system embodiment may also include:

a kernel operation module 805, configured to perform parsing, executing and/or rendering operations on downloaded page data by the IE kernel browser process based on the download status information.

In a preferable embodiment of the present invention, the download control module 803 may specifically include the following modules:

a request transmission module, configured to send the page download request to the download process when the IE kernel browser process receives the page download request;

a task adding module, configured to add the page download request to a pre-generated download task list by the download process;

an ordering module, configured to acquire a page resource type corresponding to the page download request, and in the download task list, order the page download request according to the page resource type; an

a download execution module, configured to sequentially process the page download request in the download task list to execute the corresponding page download operation.

In practice, the page download request may include URL information and the URL information may include extension name information. In this case, the page resource type corresponding to the page download request can be acquired by reading the extension name information.

In another preferred embodiment of the present invention, the download control module 803 may specifically also include the following modules:

a request transmission module, configured to send the page download request to the download process when the IE kernel browser process receives the page download request;

a file size acquisition module, configured to acquire file size information corresponding to the page download request by the download process;

a file size determination module, configured to determine whether the file size information exceeds a preset threshold value of file size, wherein if so, call a multi-threaded download module, and otherwise, call a single-threaded download module;

the multi-threaded download module, configured to employ the multi-threaded download to perform the download operation of a corresponding page; and

a single-threaded download module, configured to employ the single-threaded download to perform the download operation of the corresponding page.

In still another preferred embodiment of the present invention, the download control module 803 may specifically include the following modules:

a request transmission module, configured to send the page download request to the download process when the IE kernel browser process receives the page download request;

a cache determination module, configured to determine whether the requested file has been pre-written into a cache by the download process according to the page download request, and if so, trigger a cache extraction module; if not, trigger a server download module;

the cache extraction module, configured to extract the file from the cache; and

the server download module, configured to download a corresponding file from a server according to the page download request, and write the file into the cache.

More preferably, in the present embodiment, the download control module may also include the following modules:

a cache expiration determination module, configured to query whether the time when the file was written into the cache exceeds a preset time period before triggering the cache extraction module, if yes, call the server download module.

It is readily appreciated by a person skilled in the art that various modules in the download control module 803 may also be combined with each other and may specifically include the following examples:

### Example 1

The download control module 803 may specifically include the following modules:

a request transmission module, configured to, when the IE kernel browser process receives the page download request, send the page download request to the download process, wherein the page download request includes URL information and the URL information includes extension name information;

a task adding module, configured to add the page download request to the pre-generated download task list by the download process;

a resource ordering module, configured to read the extension name information of the page download request to acquire a corresponding page resource type, and in the download task list, order the page download request according to the page resource type;

a file size acquisition module, configured to sequentially process the page download request in the download task list to acquire file size information corresponding to the page download request;

a file size determination module, configured to determine whether the file size information exceeds a preset threshold value of file size, wherein if so, call a multi-threaded download module; and otherwise, call a single-threaded download module;

the multi-threaded download module, configured to employ a multi-threaded download to perform the download operation of a corresponding page; and

the single-threaded download module, configured to employ a single-threaded download to perform the download operation of the corresponding page.

### Example 2

The download control module 803 may specifically include the following modules:

a request transmission module, configured to, when the IE kernel browser process receives the page download request, send the page download request to the download process, wherein the page download request includes URL information and the URL information includes extension name information;

a cache determination module that is set such that the download process determine whether the requested file has been written into a cache in advance according to the page download request, wherein if so, call a cache expiration determination module; if not, call a server download module;

a cache expiration determination module, configured to query whether the time when the file was written into the cache exceeds a preset time period, if so call the server download module; if not, call the cache extraction module;

the cache extraction module, configured to extract the file from the cache; the server download module, configured to download a corresponding file from a server according to the page download request, and write the file into the cache; wherein downloading the corresponding file from the server according to the page download request is realized by calling the following modules:

a task adding module, configured to add the page download request to a pre-generated download task list by the download process;

a resource ordering module, configured to read the extension name information of the page download request to acquire the corresponding page resource type, and in the download task list, order page download request according to the page resource type; and

a download execution module, configured to sequentially process the page download request in the download task list to execute the corresponding page download operation.

### Example 3

The download control module 803 may specifically include the following modules:

a request transmission module, configured to, when the IE kernel browser process receives the page download request, send the page download request to the download process;

a cache determination module, configured to determine, by the download process, whether the requested file has been written into a cache in advance according to the page download request, wherein if so, call a cache expiration determination module; if not, call a server download module;

the cache expiration determination module, configured to query whether the time when the file was written into the cache exceeds a preset time period, if so call the server download module; if not, call a cache extraction module;

the cache extraction module, configured to extract the file from the cache;

the server download module, configured to download a corresponding file from a server according to the page download request, and write the file to the cache; wherein downloading the corresponding file from the server according to the page download request is realized by calling the following modules:

a file size acquisition module, configured to acquire file size information corresponding to the page download request by the download process;

a file size determination module, configured to determine whether the file size information exceeds a preset threshold value of file size, wherein if so, call a multi-threaded download module; and otherwise, call a single-threaded download module;

the multi-threaded download module, configured to employ a multi-threaded download to perform the download operation of a corresponding page; and

the single-threaded download module, configured to employ a single-threaded download to perform the download operation of the corresponding page.

### Example 4

The download control module 803 may specifically include the following modules:

a request transmission module, configured to, when the IE kernel browser process receives a page download request, send the page download request to the download process, wherein the page download request includes URL information and the URL information includes extension name information;

a cache determination module, configured to determine, by the download process, whether the requested file has been written into a cache in advance according to the page download request, wherein if so, call a cache expiration determination module; if not, call a server download module;

the cache expiration determination module, configured to query whether the time when the file was written into the cache exceeds a preset time period, if so call the server download module; if not, call a cache extraction module;

the cache extraction module, configured to extract the file from the cache;

the server download module, configured to download a corresponding file from a server according to the page download request, and write the file into the cache; wherein downloading the corresponding file from the server according to the page download request is realized by calling the following modules:

a task adding module, configured to add the page download request to the pre-generated download task list by the download process;

a resource ordering module, configured to read the extension name information of the page download request to acquire a corresponding page resource type, and in the download task list, order the page download request according to the page resource type;

a file size acquisition module, configured to sequentially process the page download request in the download task list to acquire file size information corresponding to the page download requests;

a file size determination module, configured to determine whether the file size information exceeds a preset threshold value of file size, wherein if so, call a multi-threaded download module; and otherwise, call a single-threaded download module.

a multi-threaded download module, configured to employ a multi-threaded download to perform the download operation of a corresponding page; and

a single-threaded download module, configured to employ a single-threaded download to perform the download operation of the corresponding page.

FIG. 9 is a block diagram schematically illustrating a system of webpage download control for an IE kernel browser according to a second system embodiment of the present invention, and specifically it may include the following modules:

a start module 901, configured to start an IE kernel browser process and start a preset download process;

a protocol registration module 902, configured to register a communication protocol in the IE kernel browser process, and wait for a page download request based on a corresponding communication protocol;

a request transmission module 903, configured to send the page download request to the download process when the IE kernel browser process receives the page download request;

a task adding module 904, configured to add the page download request to a pre-generated download task list by the download process;

an ordering module 905, configured to acquire a page resource type corresponding to the page download request, and in the download task list, order the page download request according to the page resource type;

a download execution module 906, configured to sequentially process the page download request in the download task list to perform a corresponding page download operation; an

a status reporting module 907, configured to return download status information to the IE kernel browser process during the page download procedure.

In the specific implementation, the page download request may include URL information, and the URL information may include extension name information. In this case, the page resource type corresponding to the page download request can be acquired through reading the extension name information.

In a preferred embodiment of the present invention, the system may also include the following modules:

a kernel operation module, configured to perform parsing, executing and/or rendering operations on the downloaded page data by the IE kernel browser process based on the download status information;

In order to increase a download speed, as an example of a specific application according to the embodiments of the present invention, the download execution module may specifically include the following sub-modules:

a file size acquisition sub-module, configured to acquire file size information corresponding to the page download request;

a file size determination sub-module, configured to determine whether the file size information exceeds a preset threshold value of file size, wherein if so, call a multi-threaded download sub-module; and otherwise, call a single-threaded download sub-module;

the multi-threaded download sub-module, configured to employ the multi-threaded download to perform the download operation of a corresponding page; an

the single-threaded download sub-module, configured to employ the single-threaded download to perform the download operation of the corresponding page.

In order to further improve the efficiency of downloading a file, the system embodiment may also include the following modules:

a cache determination module, configured to determine whether the requested file has been pre-written into a cache by the download process according to the page download request, and if so, trigger a cache extraction module; if not, trigger the task adding module; and

the cache extraction module, configured to extract the file from the cache;

In the embodiments of the invention, the newly downloaded file may be also written into the cache through a cache write-in module.

In a specific implementation, the system embodiment may also include:

a cache expiration determination module, configured to query whether the time when the file was written into the cache exceeds a preset time period, and if so, call the task adding module; if not, call the cache extraction module.

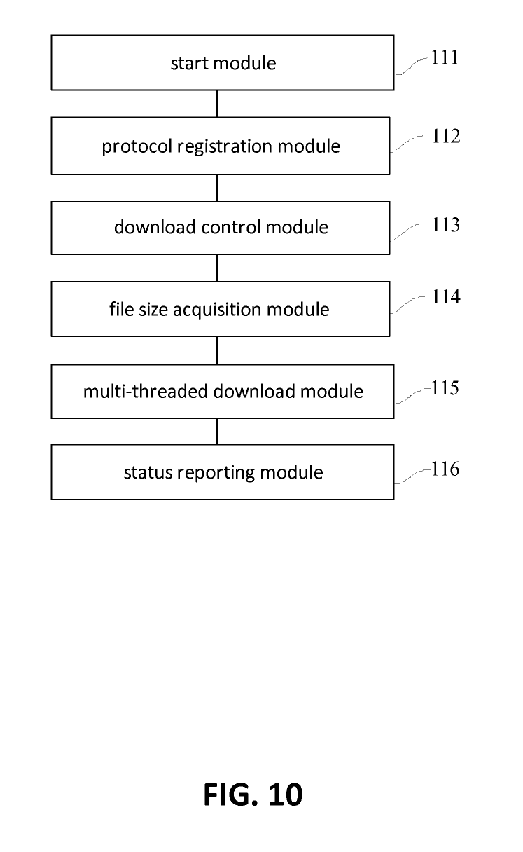

FIG. 10 is a block diagram schematically illustrating a system of webpage download control for an IE kernel browser according to a third system embodiment of the present invention, and may specifically include the following modules:

a start module 111, configured to start an IE kernel browser process and start a preset download process;

a protocol registration module 112, configured to register a communication protocol in the IE kernel browser process, and wait for a page download request based on a corresponding communication protocol;

a request transmission module 113, configured to send the page download request to the download process when the IE kernel browser process receives the page download request;

a file size acquisition module 114, configured to acquire file size information corresponding to the page download request by the download process;

a multi-threaded download module 115, configured to employ a multi-threaded download to perform the download operation of a corresponding page when the file size information exceeds a preset threshold value; and

a status reporting module 116, configured to return download status information to the IE kernel browser process during the page download procedure.

In a preferred embodiment of the present invention, the system embodiment may also include:

a single-threaded download module, configured to employ a single-threaded download to perform the download operation of the corresponding page when the file size information does not exceed the preset threshold value.

In a specific implementation, the system embodiment may also include:

a kernel operation module, configured to perform parsing, executing and/or rendering operations on downloaded page data by the IE kernel browser process based on the download status information;

In a preferred embodiment of the present invention, the system embodiment may also include:

a task adding module, configured to add the page download request to a pre-generated download task list by the download process;

an ordering module, configured to acquire a page resource type corresponding to the page download request, and in the download task list, order the page download request according to the page resource type; and

a download execution module, configured to sequentially process the page download request in the download task list and call the file size acquisition module.

Preferably, the page download request may include URL information, the URL information may include extension name information, and the page resource type corresponding to the page download request can be acquired through reading the extension name information.

In a preferred embodiment of the present invention, the system embodiment may also include:

a cache determination module, configured to determine whether the requested file has been pre-written into a cache by the download process according to the page download request, and if so, trigger a cache extraction module; if not, trigger the task adding module;

the cache extraction module, configured to extract the file from the cache; and

a cache write-in module, configured to write the downloaded file into the cache.

More preferably, the system embodiment may also include:

a cache expiration determination module, configured to query whether the time when the file was written into the cache exceeds a preset time period, and if so, call the file size acquisition module; if not, call the cache extraction module.

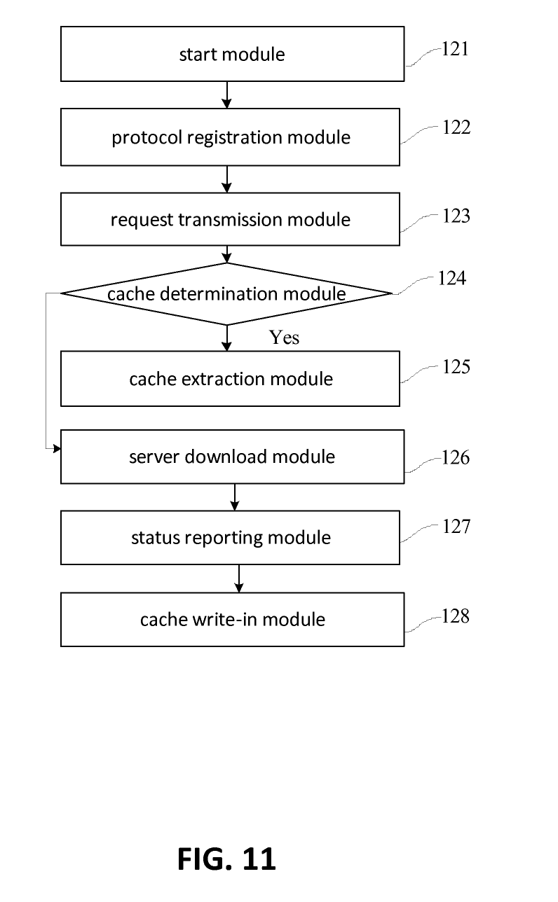

FIG. 11 is a block diagram schematically illustrating a system of webpage download control for an IE kernel browser according to a fourth system embodiment of the present invention, and specifically may include the following modules:

a start module 121, configured to start an IE kernel browser process and start a preset download process;

a protocol registration module 122, configured to register a communication protocol in the IE kernel browser process, and wait for a page download request based on a corresponding communication protocol;

a request transmission module 123, configured to send the page download request to the download process when the IE kernel browser process receives the page download request;

a cache determination module 124, configured to determine whether the requested file has been pre-written into a cache by the download process according to the page download request, and if so, trigger a cache extraction module 125; if not, trigger a server download module 126, a status reporting module 127 and a cache write-in module 208;

the cache extraction module 125, configured to extract the file from the cache;

the server download module 126, configured to download a corresponding file from a server according to the page download request;

the status reporting module 127, configured to return download status information to the IE kernel browser process during the page download procedure; and

the cache write-in module 128 that is used to write the downloaded file into the cache.

In a preferred embodiment of the present invention, the system embodiment may also include the following module:

a cache expiration determination module, configured to query whether the time when the file was written into the cache exceeds a preset time period, and if so, call the server download module, the status reporting module and the cache write-in module; if not, call the cache extraction module.

In a specific implementation, the system embodiment may also include the following module:

a kernel operation module, configured to perform parsing, executing and/or rendering operations on the downloaded page data by the IE kernel browser process based on the download status information.

In a preferred embodiment of the present invention, the server download module may include the following sub-modules:

a task adding sub-module, configured to add the page download request to a pre-generated download task list by the download process;

an ordering sub-module, configured to acquire the page resource type corresponding to the page download request, and in the download task list, order the page download request according to the page resource type;

a download execution sub-module, configured to sequentially process the page download request in the download task list to perform the corresponding page download operation.

Herein, the page download request may include URL information, and the URL information may include extension name information. In this case, the page resource type corresponding to the page download request can be acquired through reading the extension name information.

More preferably, the download execution sub-module may also include the following units:

a file size acquisition unit, configured to acquire file size information corresponding to the page download request by the download process;

a file size determination unit, configured to determine whether the file size information exceeds a preset threshold value of file size, wherein if so, call a multi-threaded download unit; and otherwise, call a single-threaded download unit;

the multi-threaded download unit, configured to employ a multi-threaded download to perform the download operation of a corresponding page; and

the single-threaded download unit, configured to employ a single-threaded download to perform the download operation of the corresponding page.

Since the above system embodiments are substantially similar to the method embodiments, the description thereof is relatively brief. As for the related parts, reference may be made to the corresponding description of the method embodiments.

Each of members according to the embodiments of the present invention can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the members of the browser device according to the embodiments of the present invention. The present invention may further be implemented as equipments or device programs (for example, computer programs and computer program products) for executing some or all of the methods as described herein. The programs for implementing the present invention may be stored in the computer readable medium, or have a form of one or more signal. Such a signal may be downloaded from the internet websites, or be provided in carrier, or be provided in other manners.

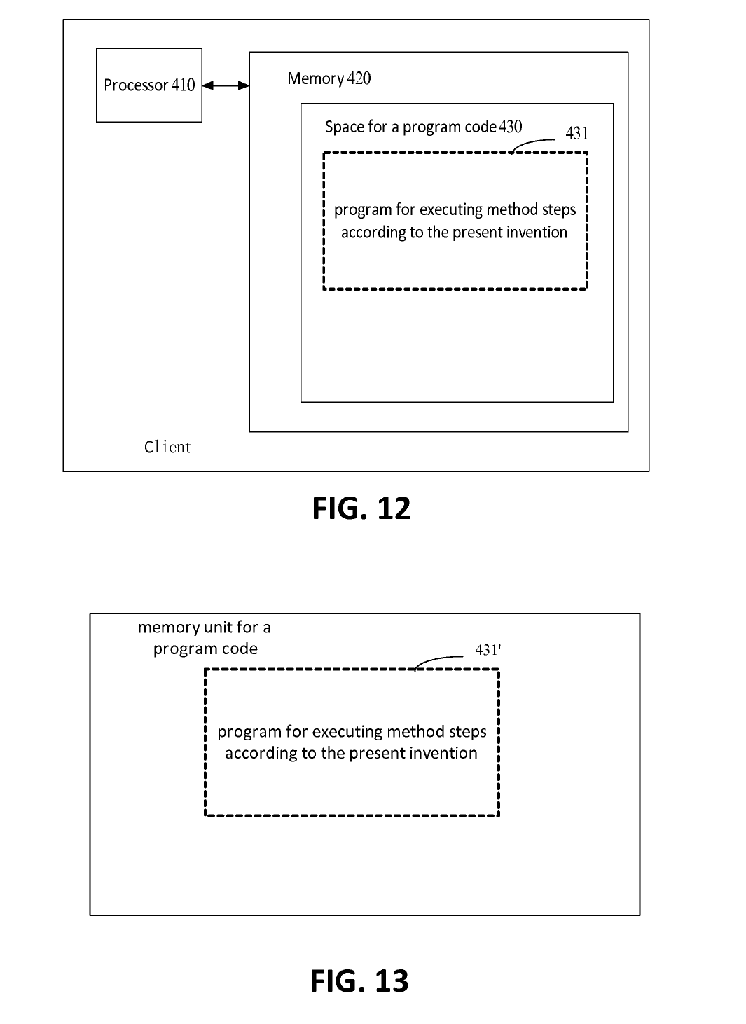

For example, FIG. 12 schematically shows a client for executing the method of webpage download control for an IE kernel browser according to the present invention. Traditionally, the client comprises a processor 410 and a computer program product or a computer readable medium in form of a memory 420. The memory 420 may be electronic memories such as a flash memory, an EEPROM (Electrically Erasable Programmable Read-Only Memory), an EPROM, a hard disk or an ROM. The memory 420 has a memory space 430 for executing a program code 431 of any steps of the above methods. For example, the memory space 430 for a program code may comprise respective program code 431 used to implement the various steps in the above mentioned method. The program code may be read from and/or be written into one or more computer program products. These computer program products comprise program code carriers such as a hard disk, a compact disk (CD), a memory card or a floppy disk. These computer program products are usually the portable or stable memory cells as shown in reference FIG. 13. The memory cells may be provided with memory sections, memory spaces, etc., similar to the memory 420 of the terminal equipment as shown in FIG. 12. The program code may be compressed in an appropriate form. Usually, the memory cell includes a computer readable code 431′ which can be read by processors such as 410. When the code is operated on the client, the client may execute each step as described in the above method. In the embodiments, the client and the computer program product or the computer readable medium included therein, may be applicable to all the method embodiments of the invention. That is, the computer program product or the computer readable medium according to the method embodiments of webpage download control for IE kernel browser of the invention also may have the same structure as above described in the embodiment of FIG. 12. Therefore, the description thereof will be omitted herein.

The terms “one embodiment”, “an embodiment” or “one or more embodiment” used herein means that, the particular feature, structure, or characteristic described in connection with the embodiments may be included in at least one embodiment of the present invention. In addition, it should be noticed that, for example, the wording “in one embodiment” used herein is not necessarily always referring to the same embodiment.

A number of specific details have been described in the specification provided herein. However, it is possible to be understood that the embodiments of present invention may be practiced without these specific details. In some examples, in order not to confuse the understanding of the specification, the known methods, structures and techniques are not shown in detail.

It should be noticed that the above-described embodiments are intended to illustrate but not to limit the present invention, and alternative embodiments can be devised by the person skilled in the art without departing from the scope of claims as appended. In the claims, any reference symbols between brackets should not form a limit of the claims. The wording “comprising” does not exclude the presence of elements or steps not listed in a claim. The wording “a” or “an” in front of element does not exclude the presence of a plurality of such elements. The present invention may be achieved by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

It should also be noticed that the language used in the present specification is chosen for the purpose of readability and teaching, rather than selected in order to explain or define the subject matter of the present invention. Therefore, it is obvious for an ordinary skilled person in the art that modifications and variations could be made without departing from the scope and spirit of the claims as appended. For the scope of the present invention, the disclosure of present invention is illustrative but not restrictive, and the scope of the present invention is defined by the appended claims.

1. A method of webpage download control for an IE kernel browser, comprising:
starting an IE kernel browser process and starting a preset download process;
registering a communication protocol in the IE kernel browser process, and waiting for a page download request based on a corresponding communication protocol;
when the IE kernel browser process receives the page download request, triggering the download process to control a page download according to a preset download rule; and
returning download status information to the IE kernel browser process during the page download procedure.

2. The method of claim 1, further comprising:
performing, by the IE kernel browser process, parsing, executing and/or rendering operations on downloaded page data based on the download status information.

3. The method of claim 1, wherein the step of registering a communication protocol in the IE kernel browser process is to register the communication protocol in the IE kernel browser process by using a RegisterNameSpace method of an IInternetSession interface, wherein the communication protocol includes an http protocol, an https protocol, a mailto protocol and an FTP protocol.

4. The method of claim 1, wherein the step of, when the IE kernel browser process receives the page download request, triggering the download process to control a page download according to a preset download rule, comprises:
when the IE kernel browser process receives the page download request, sending the page download request to the download process;
adding, by the download process, the page download request to a pre-generated download task list;
acquiring a page resource type corresponding to the page download requests, and in the download task list, ordering the page download request according to the page resource type; and
sequentially processing the page download request in the download task list and performing a corresponding page download operation.

5. The method according to claim 4, wherein the page download request includes URL information, wherein the URL information includes extension name information, and the page resource type corresponding to the page download request is acquired by reading the extension name information.

6. The method of claim 1, wherein the step of, when the IE kernel browser process receives the page download request, triggering the download process to control a page download according to a preset download rule, comprises:
when the IE kernel browser process receives the page download request, sending the page download request to the download process;
acquiring, by the download process, file size information corresponding to the page download request; and
determining whether the file size information exceeds a preset threshold value of a file size, wherein if so, employ a multi-threaded download to perform a download operation of a corresponding page; and otherwise, employ a single-threaded download to perform a download operation of a corresponding page.

7. The method of claim 1, wherein the step of, when the IE kernel browser process receives the page download request, triggering the download process to control a page download according to a preset download rule, comprises:
when the IE kernel browser process receives the page download request, sending the page download request to the download process;
determining, by the download process, whether a requested file has been written into a cache in advance according to the page download request, wherein if so, extract the file from the cache; if not, download a corresponding file from a server according to the page download request and write the file into the cache.

8. The method of claim 7, wherein the step of, when the IE kernel browser process receives the page download request, triggering the download process to control a page download according to a preset download rule, further comprises:
before the step of extracting the file from the cache for downloading, querying whether the time when the file was written into the cache exceeds a preset time period, if yes, downloading a corresponding file from the server according to the page download request and write the file into the cache.

9. The method of claim 1, wherein the step of, when the IE kernel browser process receives the page download request, triggering the download process to control a page download according to a preset download rule, comprises:
when the IE kernel browser process receives the page download request, sending the page download request to the download process; wherein, the page download request includes URL information and the URL information includes extension name information;
adding, by the download process, the page download request to a pre-generated download task list;
reading the extension name information of the page download request to acquire the corresponding page resource type, and in the download task list, and ordering the page download request according to the page resource type;
sequentially processing the page download request in the download task list, and acquiring file size information corresponding to the page download request;
determining whether the file size information exceeds a preset threshold value of a file size, wherein if so, employ a multi-threaded download to perform a download operation of the corresponding page; and otherwise, employ a single-threaded download to perform a download operation of the corresponding page.

10. The method of claim 1, wherein the step of, when the IE kernel browser process receives the page download request, triggering the download process to control a page download according to a preset download rule, comprises:
when the IE kernel browser process receives the page download request, sending the page download request to the download process, wherein the page download request includes URL information and the URL information includes extension name information;
determining, by the download process, whether a requested file has been written into a cache in advance according to the page download request, wherein if so, query whether the time when the file was written into the cache exceeds a preset time period, if yes, download the corresponding file from a server according to the page download request and write the file into the cache, and if not, extract the file from the cache;
if the file corresponding to the page download request has not been written into a cache in advance, download the corresponding file from the server according to the page download request and write the file into the cache, and
wherein, the step of downloading the corresponding file from the server according to the page download request comprises:
downloading the corresponding file from a server according to the page download request;
reading the extension name information of the page download request to acquire a corresponding page resource type, and in the download task list, ordering the page download request according to the page resource type; and
sequentially processing the page download request in the download task list to and executing the download operation of the corresponding page.

11. The method of claim 1, wherein the step of, when the IE kernel browser process receives an IE download request, triggering the download process to control a page download according to a preset download rule, comprises:
when the IE kernel browser process receives the page download request, sending the page download request to the download process;
determining, by the download process, whether the requested file has been written into a cache in advance according to the page download request, wherein if so, query whether the time when the file was written into the cache exceeds a preset time period, if yes, download the corresponding file from a server according to the page download request and write the file into the cache, and if not, extract the file from the cache;
if the file corresponding to the page download request has not been written into a cache in advance, downloading the corresponding file from the server according to the page download request and write the file into the cache;
wherein, the step of downloading the corresponding file from the server according to the page download request includes:
acquiring, by the download process, file size information corresponding to the page download request;
determining whether the file size information exceeds a preset threshold value of file size, wherein if so, employ a multi-threaded download to perform the download operation of the corresponding page; and otherwise, employ a single-threaded download to perform the download operation of the corresponding page.

12. The method of claim 1, wherein the step of, when the IE kernel browser process receives the page download request, triggering the download process to control a page download according to a preset download rule, comprises:
when the IE kernel browser process receives the page download request, sending the page download request to the download process, wherein the page download request includes URL information and the URL information includes extension name information;
determining, by the download process, whether the requested file has been written into a cache in advance according to the page download request, wherein if so, query whether the time when the file was written into the cache exceeds a preset time period, if yes, download the corresponding file from a server according to the page download request and write the file into the cache and if not, extract the file from the cache;
if the file corresponding to the page download request has not been written into cache in advance, downloading the corresponding file from the server according to the page download request and write the file into the cache;
wherein, the step of downloading the corresponding file from the server according to the page download request includes:
adding, by the download process, the page download request to the pre-generated download task list;
reading the extension name information of the page download request to acquire the corresponding page resource type, and in the download task list, ordering the page download request according to the page resource type;
sequentially processing the page download request in the download task list to acquire file size information corresponding to the page download requests;
determining whether the file size information exceeds a preset threshold value of file size, wherein if so, employ a multi-threaded download to perform the download operation of the corresponding page; and otherwise, employ a single-threaded download to perform the download operation of the corresponding page.

13-21. (canceled)

22. A method of webpage download control for an IE kernel browser, comprising:
starting an IE kernel browser process and starting a preset download process;
registering a communication protocol in the IE kernel browser process, and waiting for a page download request based on a corresponding communication protocol;
when the IE kernel browser process receives the page download request, sending the page download request to the download process;
adding, by the download process, the page download request to a pre-generated download task list;
acquiring a page resource type corresponding to the page download request, and in the download task list, ordering the page download request according to the page resource type;
sequentially processing the page download request in the download task list to perform a corresponding page download operation; and
returning download status information to the IE kernel browser process during the page download procedure.

23. The method of claim 22, wherein the step of performing a corresponding page download operation further comprises:
acquiring file size information corresponding to the page download request;
determining whether the file size information exceeds a preset threshold value of file size;
if yes, employing a multi-threaded download to perform the download operation of the corresponding page;
if not, employing a single-threaded download to perform the download operation of the corresponding page.

24. The method of claim 22, wherein before the step of adding, by the download process, the page download request to a pre-generated download task list, it further comprises:
determining whether the requested file has been written into a cache in advance by the download process according to the page download request;
if yes, extracting the file from the cache; and if not, starting executing the step of the download process adding the page download request to a pre-generated download task list.

25. The method of claim 24, wherein before the step of extracting the file from the cache, it further comprises:
querying whether the time when the file was written into the cache exceeds a preset time period, if yes, starting executing the step of the download process adding the page download request to a pre-generated download task list; and if not, executing the step of extracting the corresponding file from the cache.

26. The method of claim 25, wherein after the step of sequentially processing the page download request in the download task list to perform a corresponding page download operation, it further comprises:
writing the downloaded file into the cache.

27-57. (canceled)

58. A computer readable medium, in which a computer program is stored, wherein when the computer readable code of the computer program is operated on a client, the client executes a method of webpage download control for an IE kernel browser, comprising:
starting an IE kernel browser process and starting a preset download process;
registering a communication protocol in the IE kernel browser process, and waiting for a page download request based on a corresponding communication protocol;
when the IE kernel browser process receives the page download request, triggering the download process to control a page download according to a preset download rule; and
returning download status information to the IE kernel browser process during the page download procedure.
